(19) United States
(12) Patent Application Publication
(10) Pub. No.: US 2025/0063626 A1
(43) Pub. Date: Feb. 20, 2025

(54) WAKE UP PROCEDURES FOR ENERGY HARVESTING USER EQUIPMENT

(71) Applicant: QUALCOMM Incorporated, San Diego, CA (US)

(72) Inventors: Ahmed ELSHAFIE, San Diego, CA (US); Yuchul KIM, San Diego, CA (US); Huilin XU, Temecula, CA (US); Zhikun WU, Beijing (CN); Seyedkianoush HOSSEINI, San Diego, CA (US); Linhai HE, San Diego, CA (US); Krishna Kiran MUKKAVILLI, San Diego, CA (US); Peter GAAL, San Diego, CA (US)

(21) Appl. No.: 18/721,780

(22) PCT Filed: Feb. 23, 2022
(86) PCT No.: PCT/CN2022/077421

§ 371 Date: Jun. 19, 2024

(51) Int. Cl. H04W 76/28; H04W 72/20; H04W 72/51; H04W 92/18

(52) U.S. Cl. CPC H04W 76/28; H04W 72/20; H04W 72/51; H04W 92/18

(57) ABSTRACT

Methods, systems, and devices for wireless communication are described. A communication device may receive first control signaling indicating a discontinuous reception (DRX) configuration associated with a set of DRX cycles. The communication device may receive second control signaling during a first inactive duration and before a first active duration associated with a first DRX cycle of the set of DRX cycles. The second control signaling may indicate pending data for the communication device. Additionally or alternatively, the second control signaling may include a request for feedback from the communication device. The feedback may indicate a capability for the communication device to receive the pending data during the first active duration, and an energy level of a power source associated with the communication device. The communication device may thereby receive the pending data based in part on the feedback from the communication device.

### CROSS REFERENCE

The present application is a 371 national phase filing of International PCT Application No. PCT/CN2022/077421 by ELSHAFIE et al., entitled “WAKE UP PROCEDURES FOR ENERGY HARVESTING USER EQUIPMENT,” filed Feb. 23, 2022, which is assigned to the assignee hereof, and which is expressly incorporated by reference in its entirety herein.

### INTRODUCTION

The following relates to wireless communications in wireless communication systems, including managing energy harvesting in the wireless communication systems.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more network entities or one or more network access nodes, each simultaneously supporting communication for multiple communication devices, which may be otherwise known as user equipment (UE).

### SUMMARY

A method for wireless communication at a first device is described. The method may include receiving, from a second device, first control signaling indicating a discontinuous reception (DRX) configuration associated with a set of DRX cycles, receiving, from the second device, second control signaling during a first inactive duration and before a first active duration associated with a first DRX cycle of the set of DRX cycles, the second control signaling indicating that the second device has pending data for the first device, the second control signaling further including a request for feedback from the first device, the feedback indicating a capability for the first device to receive the pending data from the second device during the first active duration and an energy level of a power source associated with the first device, and communicating with the second device based on the second control signaling.

An apparatus for wireless communication is described. The apparatus may include a processor, and memory coupled with the processor, the processor configured to, receive, from a second apparatus, first control signaling indicating a DRX configuration associated with a set of DRX cycles, receive, from the second apparatus, second control signaling during a first inactive duration and before a first active duration associated with a first DRX cycle of the set of DRX cycles, the second control signaling indicating that the second apparatus has pending data for the apparatus, the second control signaling further including a request for feedback from the apparatus, the feedback indicating a capability for the apparatus to receive the pending data from the second apparatus during the first active duration and an energy level of a power source associated with the apparatus, and communicate with the second apparatus based on the second control signaling.

Another apparatus for wireless communication is described. The apparatus may include means for a processor, means for memory coupled with the processor, the processor configured to, means for receive, from a second apparatus, first control signaling indicating a DRX configuration associated with a set of DRX cycles, means for receive, from the second apparatus, second control signaling during a first inactive duration and before a first active duration associated with a first DRX cycle of the set of DRX cycles, the second control signaling indicating that the second apparatus has pending data for the apparatus, the second control signaling further including a request for feedback from the apparatus, the feedback indicating a capability for the apparatus to receive the pending data from the second apparatus during the first active duration and an energy level of a power source associated with the apparatus, and means for communicate with the second apparatus based on the second control signaling.

A non-transitory computer-readable medium storing code for wireless communication is described. The code may include instructions executable by a processor to a processor, memory couple with the processor, the processor configured to, receive, from a second apparatus, first control signaling indicating a DRX configuration associated with a set of DRX cycles, receive, from the second apparatus, second control signaling during a first inactive duration and before a first active duration associated with a first DRX cycle of the set of DRX cycles, the second control signaling indicating that the second apparatus has pending data for the apparatus, the second control signaling further including a request for feedback from the apparatus, the feedback indicating a capability for the apparatus to receive the pending data from the second apparatus during the first active duration and an energy level of a power source associated with the apparatus, and communicate with the second apparatus based on the second control signaling.

Some examples of the method, apparatuses, and non-transitory computer-readable medium described herein may further include operations, features, means, or instructions for transmit, from the second apparatus, third control signaling during the first inactive duration and before the first active duration associated with the first DRX cycle, the third control signaling indicating the capability for the apparatus to receive the pending data from the second apparatus during the first active duration associated with the first DRX cycle, and the energy level of the power source associated with the apparatus.

Some examples of the method, apparatuses, and non-transitory computer-readable medium described herein may further include operations, features, means, or instructions for determine the energy level of the power source associated with the apparatus and where to receive, from the second apparatus, the second control signaling, may be further based on the energy level of the power source associated with the apparatus, and where to transmit, to the second apparatus, the third control signaling may be further based on the energy level of the power source associated with the apparatus.

Some examples of the method, apparatuses, and non-transitory computer-readable medium described herein may further include operations, features, means, or instructions for receive the pending data during the first active duration associated with the first DRX cycle based on the third control signaling and the energy level of the power source associated with the apparatus.

In some examples of the method, apparatuses, and non-transitory computer-readable medium described herein, decode the second control signaling based on the energy level of the power source associated with the apparatus satisfying an energy threshold and where to transmit, to the second apparatus, the third control signaling may be further based on the decoded second control signaling.

Some examples of the method, apparatuses, and non-transitory computer-readable medium described herein may further include operations, features, means, or instructions for monitor for the second control signaling, where the processor may be further configured to and refrain from decoding the second control signaling based on the energy level of the power source associated with the apparatus being below an energy threshold.

In some examples of the method, apparatuses, and non-transitory computer-readable medium described herein, to, transmit, to the second apparatus, the third control signaling may be further based on the energy level of the power source associated with the apparatus satisfying a threshold.

Some examples of the method, apparatuses, and non-transitory computer-readable medium described herein may further include operations, features, means, or instructions for monitor for the second control signaling during the first inactive duration and before the first active duration associated with the first DRX cycle of the set of DRX cycles based on the energy level of the power source associated with the apparatus satisfying the threshold and transmit the third control signaling during the first inactive duration and before the first active duration associated with the first DRX cycle based on the energy level of the power source associated with the apparatus satisfying the threshold, where the first inactive duration may be based on a charging rate and a time for the energy level of the power source associated with the apparatus to satisfy the threshold.

Some examples of the method, apparatuses, and non-transitory computer-readable medium described herein may further include operations, features, means, or instructions for refrain to monitor for the second control signaling during the first inactive duration and before the first active duration associated with the first DRX cycle of the set of DRX cycles based on the energy level of the power source associated with the apparatus satisfying the threshold and refrain to transmit the third control signaling during the first inactive duration and before the first active duration associated with the first DRX cycle based on the energy level of the power source associated with the apparatus satisfying the threshold, where the first inactive duration may be based on a charging rate and a time for the energy level of the power source associated with the apparatus to satisfy the threshold.

Some examples of the method, apparatuses, and non-transitory computer-readable medium described herein may further include operations, features, means, or instructions for refrain to monitor for the second control signaling during the first inactive duration and before the first active duration associated with the first DRX cycle of the set of DRX cycles based on the energy level of the power source associated with the apparatus satisfying the threshold and transmit the third control signaling during the first inactive duration and before the first active duration associated with the first DRX cycle based on the energy level of the power source associated with the apparatus satisfying the threshold, where the first inactive duration may be based on a charging rate and a time for the energy level of the power source associated with the apparatus to satisfy the threshold.

Some examples of the method, apparatuses, and non-transitory computer-readable medium described herein may further include operations, features, means, or instructions for charge the power source associated with the apparatus based on the time interval, the time interval including one or more DRX cycles of the set of DRX cycles following the first DRX cycle based on the time interval for energy harvesting at the apparatus, and where, to charge the power source associated with the apparatus, the processor may be configured to accumulate solar energy, thermal energy, vibrational energy, radio frequency energy, or any combination thereof.

Some examples of the method, apparatuses, and non-transitory computer-readable medium described herein may further include operations, features, means, or instructions for receive, from the second apparatus, fourth control signaling during a second inactive duration before a second active duration associated with a second DRX cycle for the wireless communication based on the time interval, the fourth control signaling indicating the pending data associated with the wireless communication and the request for the capability of the apparatus to receive the pending data during the second active duration associated with the second DRX cycle, transmit, to the second apparatus, fifth control signaling during the second inactive duration before the second active duration associated with the second DRX cycle, the fifth control signaling indicating the capability of the apparatus to receive the pending data during the second active duration associated with the second DRX cycle, the capability indicating the energy level of the power source associated with the apparatus, and receive the pending data during the second active duration associated with the second DRX cycle based on the fifth control signaling and the energy level of the power source associated with the apparatus.

Some examples of the method, apparatuses, and non-transitory computer-readable medium described herein may further include operations, features, means, or instructions for determine a payload associated with the pending data based on the second control signaling and where to transmit, to the second apparatus, the third control signaling may be further based on the payload associated with the pending data and the energy level of the power source associated with the apparatus.

Some examples of the method, apparatuses, and non-transitory computer-readable medium described herein may further include operations, features, means, or instructions for determine a path loss value based on the second control signaling and where to transmit, to the second apparatus, the third control signaling may be further based on the path loss value and the energy level of the power source associated with the apparatus.

In some examples of the method, apparatuses, and non-transitory computer-readable medium described herein, demultiplex a set of reference signals associated with the second control signaling and where to determine the path loss value may be further based on the demultiplexed set of reference signals associated with the second control signaling.

Some examples of the method, apparatuses, and non-transitory computer-readable medium described herein may further include operations, features, means, or instructions for determine a maximum number of transport blocks or a maximum number of bits, or both, decodable by the apparatus during the first active duration of the first DRX cycle and where the third control signal indicates the maximum number of transport blocks or the maximum number of bits, or both, decodable by the apparatus during the first active duration of the first DRX cycle.

In some examples of the method, apparatuses, and non-transitory computer-readable medium described herein, the third control signaling indicates an overhead of each transport block transmission or reception associated with receiving a downlink transmission, transmitting an uplink transmission, receiving a sidelink transmission, or transmitting the sidelink transmission, or any combination thereof.

Some examples of the method, apparatuses, and non-transitory computer-readable medium described herein may further include operations, features, means, or instructions for determine a transport block size associated with the pending data, determine a resource allocation or a modulation coding scheme associated with the pending data, or both, based on the transport block size associated with the pending data, and where to communicate with the second apparatus may be further based on the resource allocation or the modulation coding scheme associated with the pending data, or both.

In some examples of the method, apparatuses, and non-transitory computer-readable medium described herein, the third control signaling indicates a per-resource power level associated with the apparatus, or a number of DRX cycles to skip the wireless communication with the apparatus, or both.

Some examples of the method, apparatuses, and non-transitory computer-readable medium described herein may further include operations, features, means, or instructions for receive fourth control signaling indicating a configuration including a set of energy states, determine an energy state associated with the set of energy states of the apparatus based on the energy level of the power source associated with the apparatus, and where to receive, from the second apparatus, the second control signaling may be further based on the energy state, and where to transmit, to the second apparatus, the third control signaling may be further based on the energy state.

In some examples of the method, apparatuses, and non-transitory computer-readable medium described herein, the set of energy states includes a first energy state associated with a first energy level, a second energy state associated with a second energy level, a third energy state associated with a third energy level, or any combination thereof, the first energy level may be greater than the second energy level and the third energy level, the second energy level may be greater than the third energy level, and the second energy state includes a subset of energy states.

Some examples of the method, apparatuses, and non-transitory computer-readable medium described herein may further include operations, features, means, or instructions for transmit, to the second apparatus, third control signaling indicating the capability for the apparatus to receive the pending data from the second apparatus based on a condition, the energy level of the power source associated with the apparatus, an energy state associated with the apparatus, or a periodicity reporting of an energy level of the power source associated with the apparatus, or any combination thereof.

Some examples of the method, apparatuses, and non-transitory computer-readable medium described herein may further include operations, features, means, or instructions for transmit, to the second apparatus, third control signaling including a buffer status report or a power headroom report, or both, indicating power, energy units, or total energy associated with a set of energy units.

In some examples of the method, apparatuses, and non-transitory computer-readable medium described herein, an energy level of the power source associated with the apparatus corresponds to an energy state of the apparatus, a maximum buffer status report associated with the apparatus, a maximum number of buffer status report bits associated with the apparatus, or any combination thereof.

Some examples of the method, apparatuses, and non-transitory computer-readable medium described herein may further include operations, features, means, or instructions for transmit, to the second apparatus, third control signaling during the first inactive duration before the first active duration associated with the first DRX cycle, the third control signaling indicating the capability for the apparatus to receive the pending data from the second apparatus during the first active duration associated with the first DRX cycle and the energy level of the power source associated with the apparatus and where the third control signal indicates an energy state associated with the apparatus, and where the third control signaling includes an uplink channel or a sidelink channel multiplexed with control information or data.

A method for wireless communication is described. The method may include outputting first control signaling indicating a DRX configuration associated with a set of DRX cycles, outputting second control signaling during a first inactive duration and before a first active duration associated with a first DRX cycle of the set of DRX cycles associated with a second apparatus, the second control signaling indicating that the apparatus has pending data for the second apparatus, the second control signaling further including a request for feedback from the second apparatus, the feedback indicating a capability for the second apparatus to receive the pending data from the apparatus during the first active duration and an energy level of a power source associated with the second apparatus, and communicate with the second apparatus based on the second control signaling.

An apparatus for wireless communication is described. The apparatus may include a processor, and memory coupled with the processor, the processor configured to, output first control signal indicating a DRX configuration associated with a set of DRX cycles, output second control signal during a first inactive duration and before a first active duration associated with a first DRX cycle of the set of DRX cycles associated with a second apparatus, the second control signaling indicating that the apparatus has pending data for the second apparatus, the second control signaling further including a request for feedback from the second apparatus, the feedback indicating a capability for the second apparatus to receive the pending data from the apparatus during the first active duration and an energy level of a power source associated with the second apparatus, and communicate with the second apparatus based on the second control signaling.

Another apparatus for wireless communication is described. The apparatus may include means for a processor, means for memory coupled with the processor, the processor configured to, means for output first control signaling indicating a DRX configuration associated with a set of DRX cycles, means for output second control signaling during a first inactive duration and before a first active duration associated with a first DRX cycle of the set of DRX cycles associated with a second apparatus, the second control signaling indicating that the apparatus has pending data for the second apparatus, the second control signaling further including a request for feedback from the second apparatus, the feedback indicating a capability for the second apparatus to receive the pending data from the apparatus during the first active duration and an energy level of a power source associated with the second apparatus, and means for communicate with the second apparatus based on the second control signaling.

A non-transitory computer-readable medium storing code for wireless communication is described. The code may include instructions executable by a processor to a processor, memory couple with the processor, the processor configured to, output first control signal indicating a DRX configuration associated with a set of DRX cycles, output second control signal during a first inactive duration and before a first active duration associated with a first DRX cycle of the set of DRX cycles associated with a second apparatus, the second control signaling indicating that the apparatus has pending data for the second apparatus, the second control signaling further including a request for feedback from the second apparatus, the feedback indicating a capability for the second apparatus to receive the pending data from the apparatus during the first active duration and an energy level of a power source associated with the second apparatus, and communicate with the second apparatus based on the second control signaling.

Some examples of the method, apparatuses, and non-transitory computer-readable medium described herein may further include operations, features, means, or instructions for obtain third control signaling during the first inactive duration and before the first active duration associated with the first DRX cycle, the third control signaling indicating the capability for the second apparatus to receive the pending data from the apparatus during the first active duration associated with the first DRX cycle and the energy level of the power source associated with the second apparatus.

In some examples of the method, apparatuses, and non-transitory computer-readable medium described herein, the third control signaling indicates a time interval for energy harvesting at the second apparatus.

In some examples of the method, apparatuses, and non-transitory computer-readable medium described herein, the third control signaling indicates a per-resource power level associated with the user equipment (UE), or a number of DRX cycles to skip the wireless communication with the UE, or both.

In some examples of the method, apparatuses, and non-transitory computer-readable medium described herein, the third control signaling includes a buffer status report or a power headroom report, or both, indicating power, energy units, or total energy associated with a set of energy units.

Some examples of the method, apparatuses, and non-transitory computer-readable medium described herein may further include operations, features, means, or instructions for output the pending data during the first active duration associated with the first DRX cycle based on the third control signaling and the energy level of the power source associated with the UE.

### BRIEF DESCRIPTION OF THE DRAWINGS

FIGS. 1 and 2 illustrate example of wireless communications systems that support wake up procedures in accordance with one or more aspects of the present disclosure.

FIG. 3 illustrates an example of a timeline that supports wake up procedures in accordance with one or more aspects of the present disclosure.

FIG. 4 illustrates an example of an energy level diagram that supports wake up procedures in accordance with one or more aspects of the present disclosure.

FIG. 5 illustrates an example of an energy state diagram that supports wake up procedures in accordance with one or more aspects of the present disclosure.

FIGS. 6 and 7 illustrate examples of process flows that support wake up procedures in accordance with one or more aspects of the present disclosure.

FIGS. 8 and 9 show block diagrams of devices that support wake up procedures in accordance with one or more aspects of the present disclosure.

FIG. 10 shows a block diagram of a communications manager that supports wake up procedures in accordance with one or more aspects of the present disclosure.

FIG. 11 shows a diagram of a system including a device that supports wake up procedures in accordance with one or more aspects of the present disclosure.

FIGS. 12 and 13 show block diagrams of devices that support wake up procedures in accordance with one or more aspects of the present disclosure.

FIG. 14 shows a block diagram of a communications manager that supports wake up procedures in accordance with one or more aspects of the present disclosure.

FIG. 15 shows a diagram of a system including a device that supports wake up procedures in accordance with one or more aspects of the present disclosure.

FIGS. 16 through 19 show flowcharts illustrating methods that support wake up procedures in accordance with one or more aspects of the present disclosure.

### DETAILED DESCRIPTION

A wireless communications system may include a communication device, such as a UE or a network entity (e.g., an eNodeB (eNB), a next-generation NodeB or a giga-NodeB, either of which may be referred to as a gNB, or some other base station), that support wireless communications over one or multiple radio access technologies. Examples of radio access technologies include 4G systems, such as LTE systems, 5G systems, which may be referred to as NR systems, or other systems and radio technologies, including future systems and radio technologies not explicitly mentioned herein (e.g., sixth generation (6G) systems). The wireless communications may include uplink transmission, uplink reception, downlink transmission, or downlink reception, sidelink transmission, sidelink reception, or a combination thereof.

A communication device, such as a UE, may operate in a low power mode also referred to as a discontinuous reception (DRX) mode. For example, in the low power mode, the communication device may periodically switch between an active state and an inactive state to improve battery power consumption. As described herein, the “active state” may refer to an ON state or an awake state related to the operation of the communication device, as well as the state of the communication device during an ON duration or active duration of the DRX cycle. The active state may be defined as the state of the UE in the DRX mode, in which the UE may perform monitoring of a channel (e.g., a downlink channel). For example, when in the active state, the UE may monitor a physical downlink control channel (PDCCH) for downlink data reception from a network entity and perform decoding of the received downlink data. The ON duration may be defined as a time duration (e.g., milliseconds, or the like) of a DRX cycle in which the UE may occupy the active state. As described herein, the “inactive state” may refer to an OFF state or a sleep state related to the operation of the communication device, as well as the state of the communication device during an OFF duration or inactive duration of the DRX cycle. The inactive state may be defined as the state of a UE in the DRX mode, in which the UE may refrain from performing monitoring of a downlink channel. For example, when in the inactive state, the UE may refrain from monitoring a PDCCH or decoding downlink data sent by a network entity to the UE. Therefore, the UE may not receive scheduling grants and assignments when in the inactive state. The OFF duration may be defined as a time duration (e.g., milliseconds) of a DRX cycle in which the UE may occupy the inactive state. In some examples, the DRX mode may correspond to a DRX operation associated with 4G systems (e.g., LTE), 5G systems (e.g., NR), sidelink DRX operation, including future systems and radio technologies not explicitly mentioned herein.

A communication device, such as a UE, may, additionally or alternatively, support energy harvesting operations. As described herein, energy harvesting may be defined as a process by which usable energy at the UE may be derived from one or more external energy sources. The communication device may perform energy harvesting operations by capturing energy from one or more external sources and converting the captured energy into an energy type which may be usable at the UE to support operations at the UE, such as wireless communication. Examples of the one or more external sources that may be used for energy harvesting include solar energy, thermal energy, vibrational energy, and radiofrequency (RF) energy, or other types of energy not explicitly mentioned herein. For example, the communication device may harvest energy using solar energy radiated from the physical environment. Additionally or alternatively, the communication device may harvest energy using thermal energy by capturing heat from the physical environment. Additionally or alternatively, the communication device may harvest energy by capturing vibrational (e.g., kinetic) energy from ambient vibrations. Additionally or alternatively, the communication device may harvest energy using RF energy from ambient RF electromagnetic waves. In future deployments, the communication device may perform energy harvesting by capturing energy released into the physical environment by the communication device and converting the captured energy into usable energy. For instance, if the UE overheats while performing UE operations, then the UE may capture the thermal energy that may be released into the environment as a result of the overheating. Additionally or alternatively, if the communication device vibrates upon receiving a notification, then the UE may capture the vibrational energy. In some examples, the communication device may store the harvested energy in a rechargeable power source (e.g., a battery), which may be referred to as a power source associated with the communication device. A rechargeable power source as described herein may be any storage unit, e.g., battery or supercapacitor.

In some examples, the communication device may recycle a part or a portion of its energy used in the communication device's vibration. For example, the communication device may be equipped with a vibration energy harvesting circuit that can partially or fully, based on some effective conversion factor, convert or recover vibration energy or kinetic energy, and convert the energy to direct current (DC) electricity. In some other examples, the communication device may recycle a part or a portion of thermal energy radiated from the communication device. The communication device may be equipped with a thermal energy harvesting circuit that can partially or fully, based on some effective conversion factor (or effect of conversion), convert or recover the thermal energy and convert the energy into DC electricity. In other examples, the communication device may recycle a part or a portion of it radio frequency (RF) energy from transmission of radio frequency signals, and convert or recover part of the RF transmission for energy harvesting as described herein. The communication device may support any type of convertible energy sources to DC energy and can be stored in a battery of the communication device.

The amount of accumulated energy stored in the power source associated with the communication device may vary. In some examples, the communication device may monitor the energy level of the power source to determine whether there is sufficient accumulated energy to support wireless communications, for example, with a network entity or other communication devices in a wireless communications system. If the communication device determines that there is insufficient accumulated energy (e.g., below a threshold), the communication device might be inaccessible by the network entity or the other communication devices for the wireless communications. Additionally, access to one or more external sources for energy harvesting operations at the communication device may be variable. For example, solar energy may not be readily available in the environment of a UE that relies on capturing ambient solar energy to perform energy harvesting operations; accordingly, the amount of energy stored in the power source associated with the UE may vary in accordance with access to solar energy. Further, an energy charging rate (e.g., accumulation of energy per time unit) at the communication device may be variable. For instance, the density of the accumulated energy may differ at various instances in time and the energy charging rate may be unpredictable in nature. Due to the variability of access to external sources for energy harvesting as well as the variability of the charging rate, the wireless communications at the communication device may be inconstant when operating in the DRX mode. That is, the network may be unaware that the communication device always has sufficient accumulated energy for data reception and transmission in accordance with the DRX cycle. Resultingly, the communication quality between the communication device and the network may be intermittent, and the reliability of wireless communications with the communication device may be improved.

As described herein, a communication device may support high reliability and low latency wireless communications by supporting signaling associated with energy harvesting operations at the communication device. For example, the communication device may support an exchange of messages between the communication device and a network communication device (also referred to as a network node or network entity) to enable high reliability and low latency wireless communications while providing power saving at the communication device. By way of example, a UE may receive a DRX configuration from a network entity, such as a base station. The DRX configuration may be associated with a set of DRX cycles for the UE. The DRX configuration may allocate, schedule, assign, configure, or the like, time and frequency resources for DRX operation, as well as other parameters that may define the UE's operation during DRX. During an inactive duration which precedes an active duration of the DRX cycle, the network entity may transmit a wake up indication (WUI) to the UE, indicating that the network entity has a pending data (e.g., buffered data) for the UE. As part of the WUI, the network entity may also indicate a request for feedback from the UE. The feedback may indicate whether the UE has the capability to receive the pending data (e.g., buffered data) from the network entity. Additionally or alternatively, the feedback may indicate an energy level of a power source (e.g., battery) associated with the UE.

Based on the WUI, the UE may transmit a wake up notification (WUN) (also referred to as a wake up response (WUR) or a wake up acknowledgement (WUA)) to the network entity during the inactive duration which precedes the active duration of the DRX cycle, indicating the capability for the UE to receive the pending data during the active duration. In some examples, the UE may indicate in the WUN that the UE has sufficient accumulated energy to receive the pending data. In some other examples, the UE may also indicate, in the WUN, the energy level of the power source associated with the UE. The UE may transition from an OFF state to an ON state in the upcoming active duration of the DRX cycle and receive the pending data from the network entity. Alternatively, the UE may indicate, in the WUN, that the UE will remain in the OFF state and continue to harvest energy until the completion of an indicated time interval (e.g., until a subsequent active duration of a subsequent DRX cycle), at which the UE may transition from the OFF state to the ON state in the subsequent active duration of the subsequent DRX cycle to receive the pending transmission. In some examples, if the UE does not send a WUA, the UE may still have to sleep or harvest energy or not monitor during the DRX cycle. In some cases, the UE may still monitor during the DRX cycle and use the harvested energy when it accumulated sufficient amount of energy to send DRX WUI/WUA for a configured time (e.g., or signaled time to harvest when WUA is not transmitted by the UE) X, where X can be L1/L2/L3 signaled and updated. This may be enabled or disabled using L1/L2/L3 signaling or configured at the UE.

Aspects of the subject matter described in the disclosure may be implemented by a communication device to support power saving. For example, a UE may avoid wasting energy by remaining in the OFF state and deferring data reception until the UE has sufficient energy for data reception. That is, the UE may refrain from waking up upon recognizing that the UE has insufficient energy for data communication. In some other examples, the communication device may support high reliability wireless communications by preventing the loss of transmissions which may result from attempts by a network entity to send a transmission to the communication device while the communication device is in the OFF state. For example, a UE may support high reliability wireless communications by providing a network entity which has a pending transmission with an indication that the UE may be unavailable or unreachable for an indicated time. By notifying the network entity that UE may be unavailable for the indicated time, the network entity may be aware that the UE will be unable to communicate with network entity during the indicated time. Thus, the network entity may refrain from sending pending transmissions to the UE during the indicated time, optimizing the utilization of network resources.

Aspects of the disclosure are initially described in the context of wireless communications systems. Aspects of the disclosure are further illustrated by and described with reference to apparatus diagrams, system diagrams, and flowcharts that relate to wake up procedures.

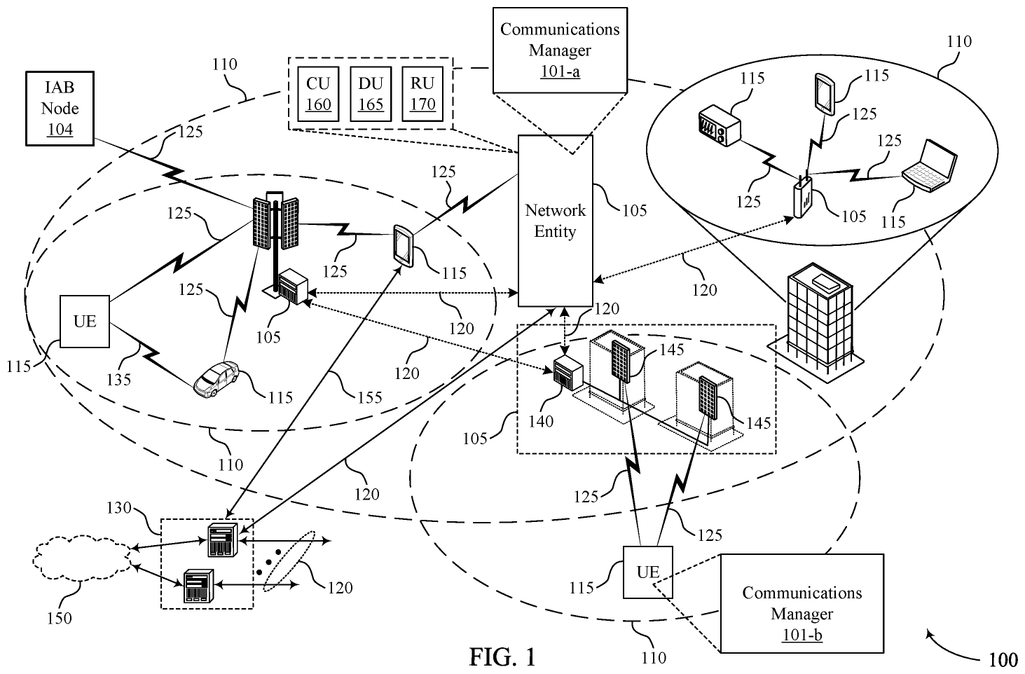

FIG. 1 illustrates an example of a wireless communications system 100 that supports wake up procedures in accordance with one or more aspects of the present disclosure. The wireless communications system 100 may include one or more network entities 105, one or more UEs 115, and a core network 130. In some examples, the wireless communications system 100 may be an LTE network, an LTE-A network, an LTE-A Pro network, or a NR network. In some examples, the wireless communications system 100 may support enhanced broadband communications, ultra-reliable communications, low latency communications, communications with low-cost and low-complexity devices, or any combination thereof.

The network entities 105 may be dispersed throughout a geographic area to form the wireless communications system 100 and may be devices in different forms or having different capabilities. In various examples, a network entity 105 may be referred to as a network element, a mobility element, a radio access network (RAN) node, or network equipment, among other nomenclature. The network entities 105 and the UEs 115 may wirelessly communicate via one or more communication links 125. Each network entity 105 may provide a coverage area 110 over which the UEs 115 and the network entity 105 may establish one or more communication links 125. The coverage area 110 may be an example of a geographic area over which a network entity 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the network entities 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, network entity 105, entity of a core network 130, apparatus, device, or computing system configured to perform any techniques described herein. For example, a network node may be a UE 115. As another example, a network node may be a network entity 105. As another example, a first network node may be configured to communicate with a second network node or a third network node. In one aspect of this example, the first network node may be a UE 115, the second network node may be a network entity 105, and the third network node may be a UE 115. In another aspect of this example, the first network node may be a UE 115, the second network node may be a network entity 105, and the third network node may be a network entity 105. In yet other aspects of this example, the first, second, and third network nodes may be different. Similarly, reference to a UE 115, a network entity 105, an apparatus, a device, or a computing system may include disclosure of the UE 115, network entity 105, apparatus, device, or computing system being a network node. For example, disclosure that a UE 115 is configured to receive information from a network entity 105 also discloses that a first network node is configured to receive information from a second network node. In this example, consistent with this disclosure, the first network node may refer to a first UE 115, a first network entity 105, a first apparatus, a first device, or a first computing system configured to receive the information; and the second network node may refer to a second UE 115, a second network entity 105, a second apparatus, a second device, or a second computing system.

As described herein, a node, which may be referred to as a node, a network node, a network entity, or a wireless node, may be a base station (e.g., any base station described herein), a UE (e.g., any UE described herein), a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a first one or more components, a first processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, generate, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, generated, sent, output, communicated, or transmitted by the first network node.

The network entities 105 may communicate with the core network 130, or with one another, or both. For example, the network entities 105 may interface with the core network 130 through one or more backhaul links 120 (e.g., via an S1, N2, N3, or other interface). The network entities 105 may communicate with one another over the backhaul links 120 (e.g., via an X2, Xn, or other interface) either directly (e.g., directly between network entities 105), or indirectly (e.g., via core network 130), or both. In some examples, the backhaul links 120 may be or include one or more wireless links. A UE 115 may communicate with the core network 130 through a communication link 155.

One or more of the network entities 105 described herein may include or may be referred to by a person having ordinary skill in the art as a network entity, a network node, a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a network entity 105, or downlink transmissions from a network entity 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications system 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with geographic coverage areas 110, among other examples.

A macro cell covers a relatively large geographic area (e.g., several kilometers in radius) and may allow unrestricted access by the UEs 115 with service subscriptions with the network provider supporting the macro cell. A small cell may be associated with a lower-powered network entity 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 may be movable and therefore provide communication coverage for a moving geographic coverage area 110. In some examples, different geographic coverage areas 110 associated with different technologies may overlap, but the different geographic coverage areas 110 may be supported by the same network entity 105. In other examples, the overlapping geographic coverage areas 110 associated with different technologies may be supported by different network entities 105. The wireless communications system 100 may include, for example, a heterogeneous network in which different types of the network entities 105 provide coverage for various geographic coverage areas 110 using the same or different radio access technologies.

The wireless communications system 100 may support synchronous or asynchronous operation. For synchronous operation, the network entities 105 may have similar frame timings, and transmissions from different network entities 105 may be approximately aligned in time. For asynchronous operation, the network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a network entity 105. Other UEs 115 in such a group may be outside the geographic coverage area 110 of a network entity 105 or be otherwise unable to receive transmissions from a network entity 105. In some examples, groups of the UEs 115 communicating via D2D communications may utilize a one-to-many (1:M) system in which each UE 115 transmits to every other UE 115 in the group. In some examples, a network entity 105 facilitates the scheduling of resources for D2D communications. In other cases, D2D communications are carried out between the UEs 115 without the involvement of a network entity 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a network entity 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or network entity 105 may be distributed across various network devices (e.g., radio heads and ANCs) or consolidated into a single network device (e.g., a network entity 105).

The wireless communications system 100 may operate using one or more frequency bands, in the range of 300 megahertz (MHz) to 300 gigahertz (GHz). The region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The electromagnetic spectrum is often subdivided, based on frequency/wavelength, into various classes, bands, channels, etc. In 5G NR two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a number of rows and columns of antenna ports that the network entity 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beam forming operations. For example, a network entity 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times in different directions. For example, the network entity 105 may transmit a signal according to different beamforming weight sets associated with different directions of transmission. Transmissions in different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a network entity 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the network entity 105 in different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or radio frequency beamforming to generate a combined beam for transmission (e.g., from a network entity 105 to a UE 115). The UE 115 may report feedback that indicates precoding weights for one or more beam directions, and the feedback may correspond to a configured number of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a network entity 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the network entity 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

Techniques described herein, in addition to or as an alternative to be carried out between network entities 105 and UEs 115, may be implemented via additional or alternative wireless devices, including IAB nodes 104, distributed units (DUs) 165, centralized units (CUs) 160, radio units (RUs) 170, and the like. For example, in some examples, aspects described herein may be implemented in the context of a disaggregated radio access network (RAN) architecture (e.g., open RAN architecture). In a disaggregated architecture, the RAN may be split into three areas of functionality corresponding to the CU 160, the DU 165, and the RU 170. The split of functionality between the CU 160, the DU 165, and the RU 170 is flexible and as such gives rise to numerous permutations of different functionalities depending upon which functions (e.g., MAC functions, baseband functions, radio frequency functions, and any combinations thereof) are performed at the CU 160, DU 165, and RU 170. For example, a functional split of the protocol stack may be employed between a DU 165 and an RU 170 such that the DU 165 may support one or more layers of the protocol stack and the RU 170 may support one or more different layers of the protocol stack.

Some wireless communications systems (e.g., wireless communications system 100), infrastructure and spectral resources for NR access may additionally support wireless backhaul link capabilities in supplement to wireline backhaul connections, providing an IAB network architecture. One or more network entities 105 may include CUs 160, DUs 165, and RUs 170 and may be referred to as donor network entities 105 or IAB donors. One or more DUs 165 (e.g., and/or RUs 170) associated with a donor network entity 105 may be partially controlled by CUs 160 associated with the donor network entity 105. The one or more donor network entities 105 (e.g., IAB donors) may be in communication with one or more additional network entities 105 (e.g., IAB nodes 104) via supported access and backhaul links. IAB nodes 104 may support mobile terminal (MT) functionality controlled and/or scheduled by DUs 165 of a coupled IAB donor. In addition, the IAB nodes 104 may include DUs 165 that support communication links with additional entities (e.g., IAB nodes 104, UEs 115, etc.) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In some examples, the wireless communications system 100 may include a core network 130 (e.g., a next generation core network (NGC)), one or more IAB donors, IAB nodes 104, and UEs 115, where IAB nodes 104 may be partially controlled by each other and/or the IAB donor. The IAB donor and IAB nodes 104 may be examples of aspects of network entities 105. IAB donor and one or more IAB nodes 104 may be configured as (e.g., or in communication according to) some relay chain.

For instance, an access network (AN) or RAN may refer to communications between access nodes (e.g., IAB donor), IAB nodes 104, and one or more UEs 115. The IAB donor may facilitate connection between the core network 130 and the AN (e.g., via a wireline or wireless connection to the core network 130). That is, an IAB donor may refer to a RAN node with a wireline or wireless connection to core network 130. The IAB donor may include a CU 160 and at least one DU 165 (e.g., and RU 170), where the CU 160 may communicate with the core network 130 over an NG interface (e.g., some backhaul link). The CU 160 may host layer 3 (L3) (e.g., RRC, service data adaption protocol (SDAP), PDCP, etc.) functionality and signaling. The at least one DU 165 and/or RU 170 may host lower layer, such as layer 1 (L1) and layer 2 (L2) (e.g., RLC, MAC, physical (PHY), etc.) functionality and signaling, and may each be at least partially controlled by the CU 160. The DU 165 may support one or multiple different cells. IAB donor and IAB nodes 104 may communicate over an F1 interface according to some protocol that defines signaling messages (e.g., F1 AP protocol). Additionally, CU 160 may communicate with the core network over an NG interface (which may be an example of a portion of backhaul link), and may communicate with other CUs 160 (e.g., a CU 160 associated with an alternative IAB donor) over an Xn-C interface (which may be an example of a portion of a backhaul link).

IAB nodes 104 may refer to a RAN node that provides IAB functionality (e.g., access for UEs 115, wireless self-backhauling capabilities, etc.). IAB nodes 104 may include a DU 165 and an MT. A DU 165 may act as a distributed scheduling node towards child nodes associated with the IAB node 104, and the MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, an IAB node 104 may also be referred to as a parent node or a child node to other IAB nodes 104, depending on the relay chain or configuration of the AN. Therefore, the MT entity of IAB nodes 104 (e.g., MTs) may provide a Uu interface for a child node to receive signaling from a parent IAB node 104, and the DU interface (e.g., DUs 165) may provide a Uu interface for a parent node to signal to a child IAB node 104 or UE 115.

For example, IAB node 104 may be referred to a parent node associated with IAB node, and a child node associated with IAB donor. The IAB donor may include a CU 160 with a wireline (e.g., optical fiber) or wireless connection to the core network, and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture (e.g., one or more IAB nodes 104 or components of IAB nodes 104) may be configured to support techniques for ROs and resources for interference mitigation in full duplex wireless communications as described herein. For example, some operations described as being performed by a UE 115 or a network entity 105 may additionally or alternatively be performed by components of the disaggregated RAN architecture (e.g., IAB nodes, DUs, CUs, etc.).

In some cases, one or more UEs 115 configured to operate with one or more components of a disaggregated RAN architecture may be referred to as disaggregated UEs. The disaggregated UEs may be configured to support techniques for ROs and resources for interference mitigation in full duplex wireless communications as described herein. In some cases, the disaggregated UEs may communicate with one or more donor network entities 105 or IAB donors. In addition, the IAB nodes 104 may include DUs 165 that support communication links with additional entities (e.g., IAB nodes 104, disaggregated UEs, etc.) within the relay chain or configuration of the access network (e.g., downstream). In such cases, one or more disaggregated UEs within the disaggregated RAN architecture may be configured to operate according to the techniques described herein.

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a network entity 105 or a core network 130 supporting radio bearers for user plane data. At the physical layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

The wireless communications system 100 may support reliable wireless communications between an energy harvesting UE 115 and a network entity 105 (or other communications devices in the wireless communications system 100). For example, a UE 115 in a low power mode may be configured to periodically power ON and OFF to improve battery power consumption. Additionally, the UE 115 may support energy harvesting operations, in which the UE 115 may accumulate energy in a rechargeable power source by harvesting energy from external sources (e.g., solar energy, thermal energy, vibrational energy, RF energy, and the like). In some examples, the UE 115 may not be accessible by a network entity 105 or other communication devices in the wireless communication system 100 until sufficient energy is accumulated by the UE 115. Due to the variability of the energy harvesting operations (e.g., access to one or more of the external sources for energy) and of the energy charging rate, wireless communications between the UE 115 and the network entity 105 (or other communications devices in the wireless communication system 100) may be unreliable when the UE 115 operates in the low power mode.

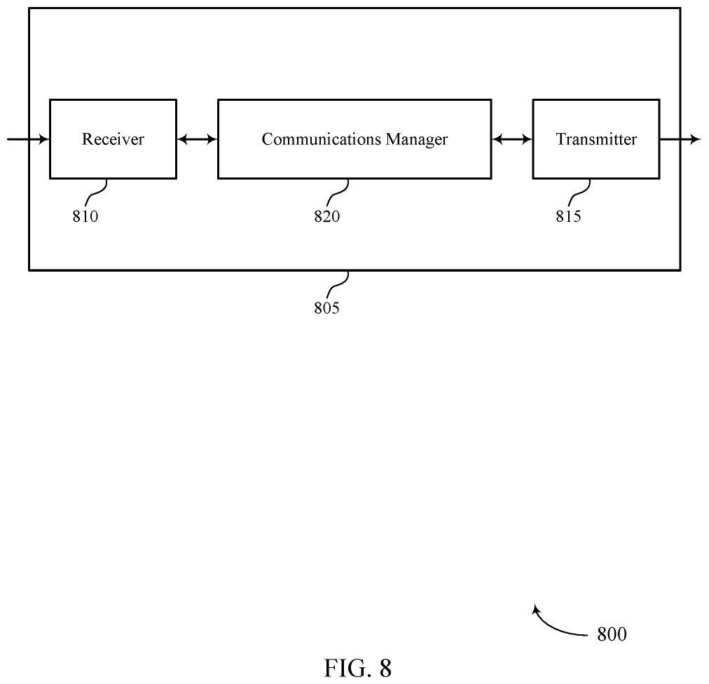

Various aspects of the present disclosure relate to enabling a network entity 105 and a UE 115 to support control signaling related to wake up procedures for wireless communication (e.g., uplink communications, downlink communications) in the wireless communications system 100. A network entity 105 may include a communications manager 101-a, and a UE 115 may include a communications manager 101-b in accordance with examples as disclosed herein. The communications manager 101 may be an example of aspects of a communications manager as described in FIGS. 8 through 15.

The communications manager 101 may support exchange of control signaling and pending data between the network entity 105 and the UE 115. For example, the communications manager 101-a may output or transmit, and the communications manager 101-b may receive or obtain, control signaling that indicates a DRX configuration for the UE 115. The communications manager 101-a may output or transmit, in accordance with the DRX configuration, control signaling that indicates that the network entity 105 has pending data for the UE 115 and requests feedback indicating a capability for the UE 115 to receive the pending data and an energy level of the power source (e.g., a battery level) associated with the UE 115. Based on the control signaling exchanged between the communications manager 101-a and the communications manager 101-b, the UE 115 may effectively communicate with the network entity 105 or other communication devices in the wireless communications system 100 as described herein.

In some cases, the network entity 105, the UE 115, or any combination thereof may be configured with circuitry that may support energy harvesting operations. The circuitry may include one or multiple circuit elements, such as resistors, transistors, capacitors, inductors, amplifiers, diodes, among other examples, that may be coupled (e.g., operatively, communicatively, functionally, electronically, or electrically) with each other to support energy harvesting operations at the network entity 105, the UE 115, or any combination thereof. The circuitry may receive energy from one or more external energy sources, as described herein, and may process (e.g., collect, convert, transform) the energy via the one or multiple circuit elements, such as resistors, transistors, capacitors, inductors, amplifiers, diodes, among other examples, to charge a power source of the network entity 105, the UE 115, or any combination thereof.

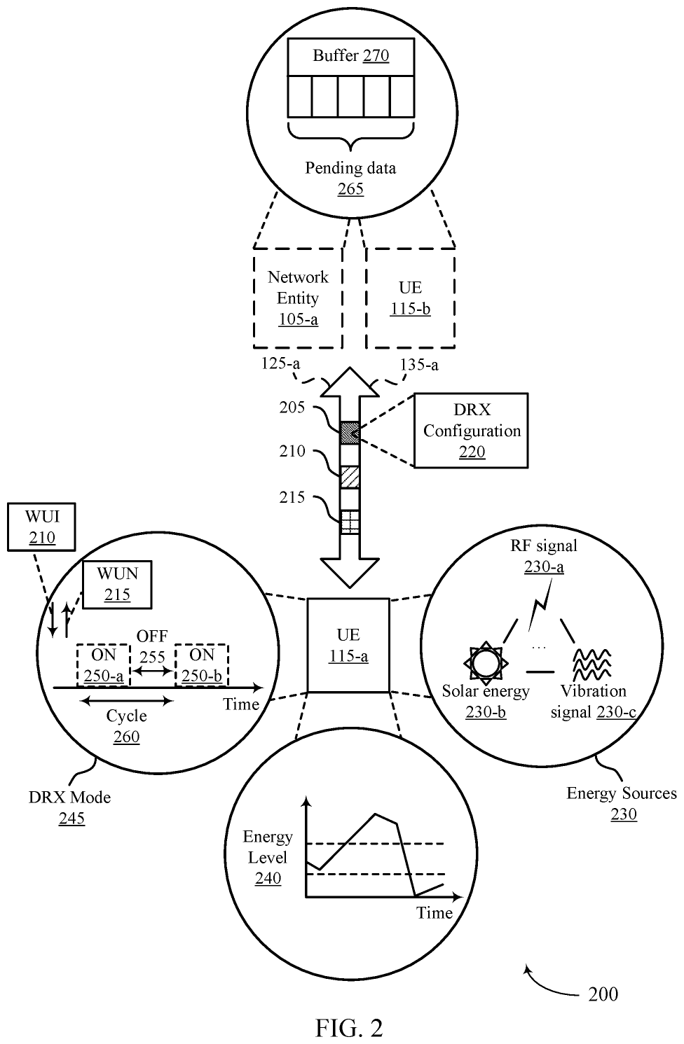

FIG. 2 illustrates an example of a wireless communications system 200 that supports wake up procedures in accordance with one or more aspects of the present disclosure. The wireless communications system 200 may implement or be implemented by aspects of the wireless communications system 100. For example, the wireless communications system 200 may include a network entity 105-a and a UE 115-a, which may be examples of a network entity 105 (or other network entity) and a UE 115 as described with reference to FIG. 1. The network entity 105-a and the UE 115-a may communicate with one another via a communication link 125-a, which may be an example of a communication link 125 as described with reference to FIG. 1. In other cases, the UE 115-a may perform sidelink communication with a UE 115-b via a D2D communication link 135-a, which may be an example of a D2D communication link 135 as described with reference to FIG. 1. The wireless communications system 200 may support multiple radio access technologies including 4G systems such as LTE systems, LTE-A systems, or LTE-A Pro systems, and 5G systems, which may be referred to as NR systems.

In some examples, the UE 115-a may be a relatively low-power device, such as an IoT device, and may perform energy harvesting procedures in order to accumulate energy. That is, the UE 115-a may harvest energy from energy sources 230 in the wireless communication system 200 to maintain or increase the energy level of the UE 115-a and perform wireless operations (e.g., communicate with the network entity 105-a, communicate with the UE 115-b). In some examples, the UE 115-a may accumulate energy via RF signal 230-a. In some other examples, the UE 115-a may accumulate energy via solar energy 230-b. In other examples, the UE 115-a may accumulate energy via vibration signal 230-c. In some other examples, the UE 115-a may accumulate energy via thermal energy. In the example of FIG. 2, one or more of the energy sources 230 may be intermittently available to be accumulated by the UE 115-a. Thus, the UE 115-a may rely on a rechargeable power source having the capability to harvest and store energy.

In some examples, the UE 115-a may perform monitoring of an energy level 240 of the UE 115-a to determine whether there is sufficient accumulated energy at the UE 115-a to support wireless communication with the network entity 105-a or other communication devices in the wireless communications system 200. That is, the UE 115-a may determine the energy level 240 of the UE 115-a during instances in which the UE 115-a may be charging, discharging, or maintaining an energy level. In some cases, the availability of one or more of the energy sources 230 may be unpredictable in nature and the energy charging rate of the UE 115-a may vary.

The UE 115-a may communicate with the network entity 105-a or the UE 115-b in accordance with the intermittently available accumulated energy. For instance, if the energy level 240 of the UE 115-a is not sufficient for communication, the UE 115-a may be unreachable by the network entity 105-a until enough energy is accumulated at the UE 115-a. Resultingly, wireless communication between the network entity 105-a and the UE 115-a via the communication link 125-a may depend on the energy level 240 of the UE 115-a. In other cases, if the energy level 240 of the UE 115-a is not sufficient for communication, the UE 115-a may be unreachable by the UE 115-b until enough energy is accumulated at the UE 115-a. Accordingly, wireless communication between the UE 115-b and the UE 115-a via the D2D communication link 135-a may depend on the energy level 240 of the UE 115-a.

In some examples, the UE 115-a may operate in a duty cycled mode, such as a DRX mode 245, to reduce power consumption at the UE 115-a. That is, the UE 115-a may be configured to be active (e.g., during an ON duration 250) and inactive periodically over time when in the DRX mode 245. Based on a DRX configuration 220, the UE 115-a may be configured for a set of active durations (e.g., ON durations 250) and a set of inactive durations (e.g., OFF durations 255) in accordance with a cycle 260 (e.g., a DRX cycle). For instance, the UE 115-a may be configured for a first active duration (e.g., an ON duration 250-a) followed by an inactive duration (e.g., an OFF duration 255) during the cycle 260 before repeating the cycle beginning with a second active duration (e.g., an ON duration 250-b). When the UE 115-a operates within the inactive duration (e.g., the OFF duration 255), any transmission which the network entity 105-a transmits to the UE 115-a may be lost (e.g., not received or decoded at the UE 115-a). Additionally or alternatively, when the UE 115-a operates within the inactive duration (e.g., the OFF duration 255), any sidelink transmission which the UE 115-b transmits to the UE 115-a may be lost. As such, the UE 115-a may be available for data reception and transmission based on the DRX configuration 220 as well as the energy level 240 of the UE 115-a.

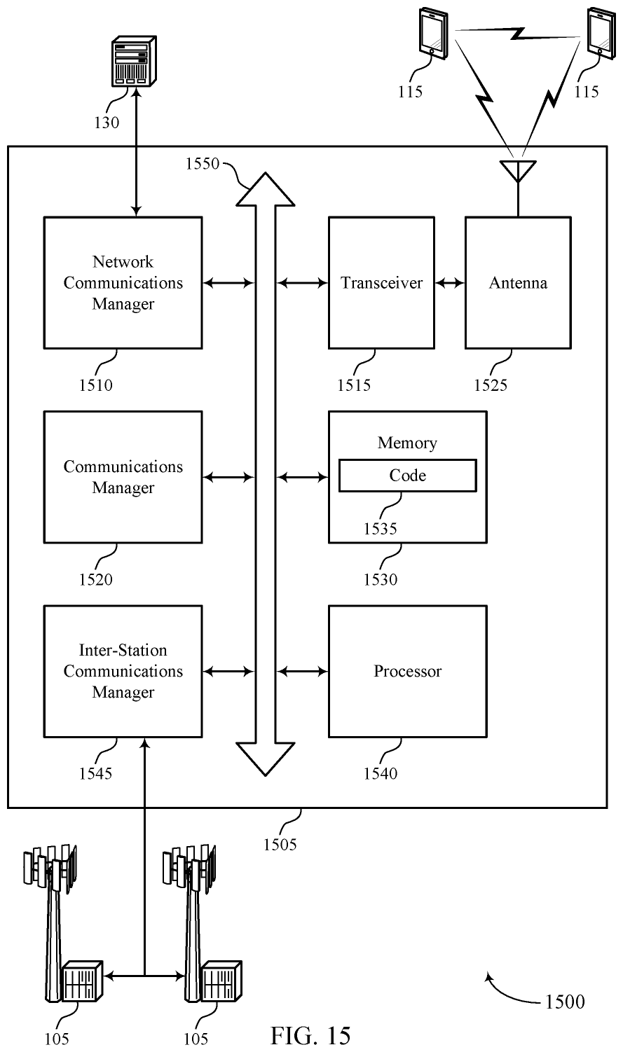

In some examples, the network entity 105-a may have pending data buffered for transmission to the UE 115-a. For instance, the network entity 105-a may store pending data 265 (e.g., pending data packets) within a buffer 270 in order to prepare the pending data 265 for downlink communication to the UE 115-a. The buffer 270 may be a memory (e.g., such as memory 1530 as described herein with reference to FIG. 15) to temporarily store pending data, such as the pending data 265 at the network entity 105-a or the UE 115-b as described herein. The energy level 240 of the UE 115-a may, in some cases, decline rapidly due to continuous energy consumption while the UE 115-a communicates data with the network entity 105-a. Additionally, if the network entity 105-a transmits the pending data 265 to the UE 115-a when the UE 115-a is in the inactive state (e.g., during the OFF duration 255), the pending data 265 may be lost. Consequently, the network entity 105-a may reduce power consumption by taking the energy level 240 of the UE 115-a into account before sending the pending data 265 to the UE 115-a.

In other examples, the UE 115-b may have the pending data 265 buffered for transmission to the UE 115-a. For instance, the UE 115-b may store the pending data 265 within the buffer 270 in order to prepare the pending data 265 for sidelink communication to the UE 115-a. In such examples, the buffer 270 may be a memory (e.g., such as memory 1530 as described herein with reference to FIG. 15) to temporarily store pending data, such as the pending data 265 at the UE 115-b as described herein. The energy level 240 of the UE 115-a may decline rapidly due to continuous energy consumption while the UE 115-a communicates data with the UE 115-b. Additionally, if the UE 115-b transmits the pending data 265 to the UE 115-a when the UE 115-a is in the inactive state, the pending data 265 may be lost. Resultingly, the UE 115-b may reduce power consumption by taking the energy level 240 of the UE 115-a into account before sending the pending data 265 to the UE 115-a.

The present disclosure provides techniques for enabling the UE 115-a and a network device (e.g., the network entity 105-a, the UE 115-b, other communications devices in the wireless communications system 200) to support the exchange of control signaling related to wake up procedures for an energy harvesting device in accordance with one or more aspects of the present disclosure. As described herein, the energy harvesting device may be a communication device, such as the UE 115-a, in the wireless communications system 200 that has the capability to perform energy harvesting operations by capturing energy from external sources and converting the captured energy into stored energy which may be used by the communication device for wireless communication as described herein. The control signaling may enable the network entity 105-a to communicate data (e.g., the pending data 265) with the UE 115-a based on whether the UE 115-a has sufficient harvested energy. Additionally or alternatively, the control signaling may enable the UE 115-b to communicate data (e.g., the pending data 265) with the UE 115-a based on whether the UE 115-a has sufficient harvested energy.

In the example of FIG. 2, the UE 115-a may receive, from the network entity 105-a, a first control signaling 205 indicating the DRX configuration 220 to be associated with a set of DRX cycles for wireless communication. The UE 115-a may receive, from the network entity 105-a, second control signaling carrying a WUI 210. The WUI 210 may indicate the pending data 265, a request for a capability of the UE 115-a to receive the pending data 265, and the energy level 240 of the power source associated with the UE 115-a. The UE 115-a may communicate with the network entity 105-a based on receiving the WUI 210. For instance, the UE 115-a may transmit a WUN 215, also referred to as third control signaling, to the network entity 105-a, if the UE 115-a determines that the energy level 240 of the UE 115-a is sufficient for wireless communication. The WUN 215 may indicate the capability of the UE 115-a to receive the pending data 265. Additionally, the WUN 215 may indicate the energy level 240 of the power source associated with the UE 115-a. For example, the WUN 215 may indicate that the UE 115-a has sufficient energy (e.g., equal to or greater than a threshold) to communicate data while also indicating the energy level 240 of the UE 115-a.

Additionally or alternatively, the UE 115-a may receive, from the UE 115-b, the first control signaling 205 indicating the DRX configuration 220 to be associated with a set of DRX cycles for sidelink wireless communication. The UE 115-a may receive, from the UE 115-b, the second control signaling carrying the WUI 210. In some examples, the UE 115-a may communicate with the UE 115-b based on receiving the WUI 210. For instance, the UE 115-a may transmit the WUN 215 to the UE 115-b if the UE 115-a determines that the energy level 240 of the UE 115-a is sufficient for sidelink wireless communication.

The UE 115-a may receive, from the network entity 105-a or the UE 115-b, or both, an indication to operate according to at least one or more modes during a duration. In some examples, the UE 115-a may monitor for the WUI 210 and transmit the WUN 215, for example, if the UE 115-a has sufficient energy (e.g., equal to or greater than a threshold). In some other examples, the UE 115-a may refrain from monitoring (e.g., not monitor) for the WUI 210 until the duration lapses (e.g., a timer expires). In this example, the network entity 105-a or the UE 115-b is not expected to transmit the WUI 210 to the UE 115-a. In other examples, the UE 115-a may refrain from monitoring (e.g., not monitor) for the WUI 210, but the UE 115-a may transmit the WUN 215, for example, if the UE 115-a has sufficient energy (e.g., equal to or greater than a threshold).

The network entity 105-a, the UE 115-a, or the UE 115-b, or any combination thereof, may determine the length of the duration based on when the UE 115-a may have sufficient energy (e.g., equal to or greater than a threshold). This determination may be based on a charging rate of the UE 115-a. That is, the network entity 105-a, the UE 115-a, or the UE 115-b, or any combination thereof, may determine when the UE 115-a may have sufficient energy based on the charging rate (e.g., accumulation of energy per time unit). As such, the network entity 105-a or the UE 115-b may avoid wasting energy (e.g., by unnecessary retransmitting WUIs to the UE 115-a) and the UE 115-a may transmit the WUN 215 to notify the network entity 105-a or the UE 115-b that it has sufficient energy for information (e.g., buffer status report) sent by the network entity 105-a or the UE 115-b in a previous WUI. For example, in response to the previous WUI, the UE 115-a may have responded by requesting for extra number of symbols for charging the power source of the UE 115-a.

As described, control signaling related to energy harvesting may enable the network entity 105-a or the UE 115-b, or both to communicate with the UE 115-a when the UE 115-a is deemed to have sufficient energy. Accordingly, the wireless communications system 200 may provide for more reliable communication between the network entity 105-a and the UE 115-a, the UE 115-b and the UE 115-a, or both by preventing the loss of transmissions which may occur if transmissions are sent to the UE 115-a while the UE 115-a is in an inactive state during an OFF duration (e.g., during the OFF duration 255). Further, the wireless communication system 200 may prevent the network entity 105-a, the UE 115-b, or both from using radio resources unnecessarily by accounting for the energy level of the UE 115-a before attempting to send pending data to the UE 115-a.

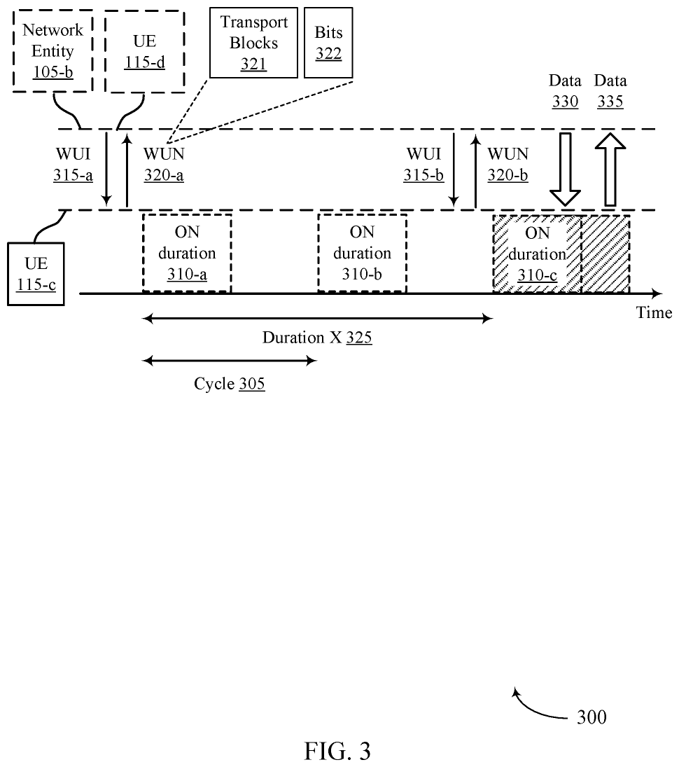

FIG. 3 illustrates an example of a timeline 300 that supports wake up procedures in accordance with one or more aspects of the present disclosure. In some examples, the timeline 300 may implement or be implemented by aspects of the wireless communications systems 100 and 200 as described with reference to FIGS. 1 and 2, respectively. For example, the timeline 300 may be implemented by a network entity 105-b (or other network entity) and a UE 115-c, which may be an example of a network entity 105 and a UE 115 as described with reference to FIGS. 1 and 2, respectively. Additionally or alternatively, the timeline 300 may be implemented by a UE 115-d and the UE 115-c, which may be examples of UEs 115 as described with reference to FIGS. 1 and 2. The timeline 300 may be implemented by the network entity 105-b and the UE 115-c, or the UE 115-d and the UE 115-c, or both to exchange control signaling when the UE 115-c operates in a DRX mode to promote power saving at the UE 115-c.

The timeline 300 may illustrate an example of a UE 115-c transmitting and receiving control signaling while operating in DRX mode. In some examples, the UE 115-c may receive a first control signaling which indicates a DRX configuration. The UE 115-c in DRX mode may behave based on the DRX configuration, which includes a set of active durations (e.g., one or more ON durations 310) and a set of inactive durations that are associated with a set of DRX cycles. For example, the UE 115-c may begin a first DRX cycle, such as cycle 305, by starting an ON duration 310-a; then, the UE 115-c may end the ON duration 310-a and be inactive until the cycle 305 is complete. After the cycle 305, the UE 115-c may begin a second DRX cycle with an ON duration 310-b and behave similarly to how the UE 115-c behaved during the cycle 305. Although the UE 115-c may be configured to continue operating actively and inactively over a pattern of DRX cycles as such, the UE 115-c may be able to skip one or more of the ON durations 310.

In some examples, the UE 115-c may receive, from the network entity 105-b, the UE 115-d, or both, a second control signaling which may include a WUI 315. Within the second control signaling, the WUI 315-a may indicate that the network entity 105-b, the UE 115-d, or both has pending data for the UE 115-c and to inquire whether or not the UE 115-c is capable of waking up to receive the pending data during the ON duration 310-a (e.g., a first active duration). Additionally, the WUI 315-a may request the energy level of the power source associated with the UE 115-c. In some cases, the WUI 315-a may indicate the amount of data that is buffered in the network. For instance, the network entity 105-b may indicate the amount of pending data for the UE 115-c. Additionally or alternatively, the UE 115-d may indicate the amount of pending data for the UE 115-c. In some examples, the network entity 105-b, the UE 115-d, or both may include the latest value for the pathloss to be used in power allocation for uplink communications within the WUI 315-a. In other examples, the WUI 315-a may include a set of reference signals so that the UE 115-c may demultiplex the set of reference signals and determine the pathloss. In other cases, the UE 115-c may estimate the pathloss by using one or more synchronization signal blocks (SSBs) that correspond to the set of reference signals. Components of each SSB, including a primary synchronization signal (PSS), a secondary synchronization signal (SSS), and a demodulation reference signal (DMRS) belonging to a physical broadcast channel (PBCH), may be used by the UE 115-c to estimate the pathloss.

The timing of a WUI 315 may be preconfigured between the network entity 105-b and the UE 115-c. For example, the network entity 105-b may intend to transmit pending data to the UE 115-c during the ON duration 310-a. Accordingly, the WUI 315-a may be sent by the network entity 105-b and received by the UE 115-c before the ON duration 310-a. Additionally or alternatively, the timing of the WUI 315 may be preconfigured between the UE 115-d and the UE 115-c. For example, the UE 115-d may intend to transmit pending data to the UE 115-c during the ON duration 310-a. Accordingly, the WUI 315-a may be sent by the UE 115-d and received by the UE 115-c before the ON duration 310-a.

While the network entity 105-b, the UE 115-d, or both may send the WUI 315-a to the UE 115-c, the UE 115-c may determine whether or not the WUI 315-a may be received based on whether the UE 115-c has sufficient accumulated energy to do so. For instance, the UE 115-c may determine to receive the WUI 315-a based on the energy level of the power source of the UE 115-c. If the UE 115-c determines that the WUI 315-a may be received, the UE 115-c may monitor for the WUI 315-a. Alternatively, the UE 115-c may refrain from monitoring for the WUI 315-a. Additionally or alternatively, the UE 115-c may determine whether or not to decode the WUI 315-a based on the energy level of the power source associated with the UE 115-c. For example, the UE 115-c may monitor for the WUI 315-a but refrain from decoding the WUI 315-a if the UE 115-c determines that the energy level of the power source associated with the UE 115 is below an energy threshold.

In some examples, the UE 115-c may transmit a WUN 320-a, also referred to as the third control signaling, to the network entity 105-b. In other examples, the UE 115-c may transmit the WUN 320-a to the UE 115-d. The WUN 320-a may be used to indicate whether or not the UE 115-c is capable of receiving the pending data during the ON duration 310-a. Additionally, the WUN 320-a may indicate the energy level of the power source associated with the UE 115-c. The UE 115-c may transmit the WUN 320-a based on the energy level of the power source associated with the UE 115-c and on the WUI 315-a. In some examples, the UE 115-c may determine a payload associated with the pending data based on the WUI 315-a. Accordingly, the UE 115-c may transmit the WUN 320-a based on the payload associated with the pending data as well as the energy level of the power source associated with the UE 115-c.

In some cases, the UE 115-c may determine a maximum number of transport blocks, maximum number of bits, or a combination thereof, that can be decoded by the UE 115-c during the ON duration 310-a. Each transport block transmission or reception indicated by the UE 115-c may be associated with a known cost (e.g., overhead signaling, transmit power, or the like). For instance, a unit of an uplink or downlink channel (e.g., physical downlink shared channel (PDSCH), physical downlink control channel (PDCCH), physical uplink shared channel (PUSCH), or physical uplink control channel (PUCCH)) may cost the UE 115-c a certain amount of power to transmit or receive. Thus, the UE 115-c may determine a maximum number of transport blocks 321, maximum number of bits 322, or a combination thereof, and indicate the determined maximum value within the WUN 320-a.

In some examples, the UE 115-c may indicate an uplink buffer status report (BSR) as well as suggested transport block sizes (e.g., a suggested number of transport blocks or number of bits to transfer) within the WUN 320-a. In some cases, the UE 115-c may determine the uplink BSR based on a downlink BSR which may be indicated within the WUI 315-a. For example, the UE 115-c may determine an amount of energy remaining after the downlink BSR and transmit the maximum number of BSR bits in accordance with the determined amount of energy remaining. In other cases, the UE 115-c may determine the uplink BSR as well as the number of transport blocks to send to the network entity 105-b, the UE 115-d, or both based on the energy level of the power source associated with the UE 115-c. Additionally, the UE 115-c may determine the total transmit power, Pₘₐₓ, for a single OFDM symbol transmission based on a pathloss value, the number of RBs per OFDM symbol, and a given target power for an RB (Po). Assuming an M number of RBs and an N number of OFDM symbols may be used to transmit a single transport block and without accounting for DMRS, a number of resource elements (REs) used to transmit a single transport block may be estimated by RE=12*M*N. Thus, the total transmit power for a single transport block may be estimated as Pₘₐₓ*N. By determining the total transmit power for a single transport block, the UE 115-c may determine the charging behavior of the UE 115-c.

In some examples, the UE 115-c may determine a resource allocation or a modulation coding scheme (MCS) for a pending data transmission. If one layer is used for the UE 115-c, the number of bits (e.g., transport block size) to be transmitted (N_{info}) may be determined by N_{info}=RE*spectral_eff, where spectral_eff represents the MCS index or the spectral efficiency. Given N_{info} and spectral_eff, the number of REs may be determined by RE=12*M*N. In cases in which RE is fixed using preconfigured or configured resources, such as configured or dynamic grants, the MCS index may be determined by the UE 115-c. Thus, the UE 115-c may determine the uplink BSR and the suggested transport block sizes. Further, the UE 115-c may indicate an overhead of each transport block transmission associated with receiving a downlink transmission, as well as an overhead of each transport block reception associated with transmitting an uplink transmission.

In some cases, the UE 115-c may indicate a fixed-per-symbol power within the WUN 320-a regardless of pathloss. In other words, the UE 115-c may indicate a per-resource power level associated with the UE 115-c within the WUN 320-a. For example, the UE 115-c may indicate a preferred Pₘₐₓ, which the network entity 105-b, the UE 115-d, or both may use to allocate the number of REs for a transport block transmission. In addition to the BSR, the UE 115-c may indicate a power headroom report within the WUN 320-a, indicating power, energy units, or total energy associated with a set of energy units. In some examples, the BSR and the power headroom report may be signaled via RRC, MAC-CE, or during random access (e.g., using SIB).

In some cases, the UE 115-c may determine to refrain from sending the WUN 320-a to the network entity 105-b, the UE 115-d, or both after receiving the WUI 315-a. For instance, after receiving the WUI 315-a, the UE 115-c may determine that sufficient energy has been accumulated to receive the WUI 315-a and decode the WUI 315-a. However, the UE 115-c may determine that not enough energy has been accumulated to transmit the WUN 320-a. Accordingly, the UE 115-c may determine to skip sending the WUN 320-a. The UE 115-c may reduce power consumption for delay tolerant traffic by waking up less frequently and deferring reception. Thus, the UE 115-c may avoid frequent wake ups and save power by determining to skip sending the WUN 320-a.

Alternatively, the UE 115-c may determine that there is enough energy accumulated to transmit the WUN 320-a. For instance, after receiving the WUI 315-a, the UE 115-c may determine that there is enough energy accumulated to receive the WUI 315-a, decode the WUI 315-a, and transmit the WUN 320-a. In some examples, the WUN 320-a may indicate that the UE 115-c will not wake up for a time interval (e.g., X seconds or X cycles) in which the UE 115-c may harvest energy. For example, the UE 115-c may transmit the WUN 320-a, indicating that the UE 115-c will not wake up for a duration X 325. The duration X 325 may include one or more DRX cycles which succeed the cycle 305. Accordingly, the UE 115-c may not wake up during the duration X 325 by skipping an ON duration 310-b, as well as any other active durations within the duration X 325 which the DRX configuration scheduled to occur. During the duration X 325, the UE 115-c may charge the power source associated with the UE 115-c by harvesting energy from a variety of external sources for energy (e.g., solar energy, thermal energy, vibrational energy, RF energy, etc.). The network entity 105-b, the UE 115-d, or both may conserve network resources by refraining from sending the WUI 315-a until the UE 115-c reaches a second inactive duration that precedes an ON duration 310-c (a second active duration). Additionally, the network entity 105-b, the UE 115-d, or both may use the information provided by the WUN 320-a to inform other network devices that the UE 115-c will not be reachable for the duration X 325.

The ON duration 310-c may be associated with a DRX cycle succeeding the duration X 325 (e.g., a second DRX cycle). Accordingly, the network entity 105-b may transmit a fourth control signaling carrying a WUI 315-b during the second inactive duration. Additionally or alternatively, the UE 115-d may transmit the fourth signaling carrying the WUI 315-b during the second inactive duration. After receiving the WUI 315-b, the UE 115-c may transmit the WUN 320-b, indicating that the UE 115-c will wake up and be able to participate in data communication with the network entity 105-b, the UE 115-d, or both during the ON duration 310-c.

In some examples, the UE 115-c may determine a transport block size associated with pending data. Additionally, the UE 115-c may determine a resource allocation or a MCS associated with the pending data based on determining the transport block size associated with the pending data. The UE 115-c may communicate with the network entity 105-b, the UE 115-d, or both based on the resource allocation or the MCS associated with the pending data. Accordingly, the UE 115-c may receive the pending data (e.g., data 330) during the ON duration 310-c from the network entity 105-b. Additionally or alternatively, the UE 115-c may transmit the pending data uplink (e.g., data 335) during the ON duration 310-c to the network entity 105-b. Additionally or alternatively, the UE 115-c may perform sidelink data communication with the UE 115-d by transmitting or receiving the pending data (e.g., data 335) during the ON duration 310-c.

In some examples, the network entity 105-b may transmit, and the UE 115-c may receive, a WUI on downlink resources. Downlink and uplink resources may be configured resources or occasions. In some other examples, the UE 115-d may transmit, and the UE 115-c may receive, a WUI on sidelink resources. For sidelink, signaling may be transmitted on sidelink resources, which may be configured resources or occasions. In some examples, the UE 115-c may transmit, and the network entity 105-b may receive, a WUI/WUA on uplink resources. In some other examples, the UE 115-c may transmit, and the UE 115-d may receive, a WUI/WUA on sidelink resources.

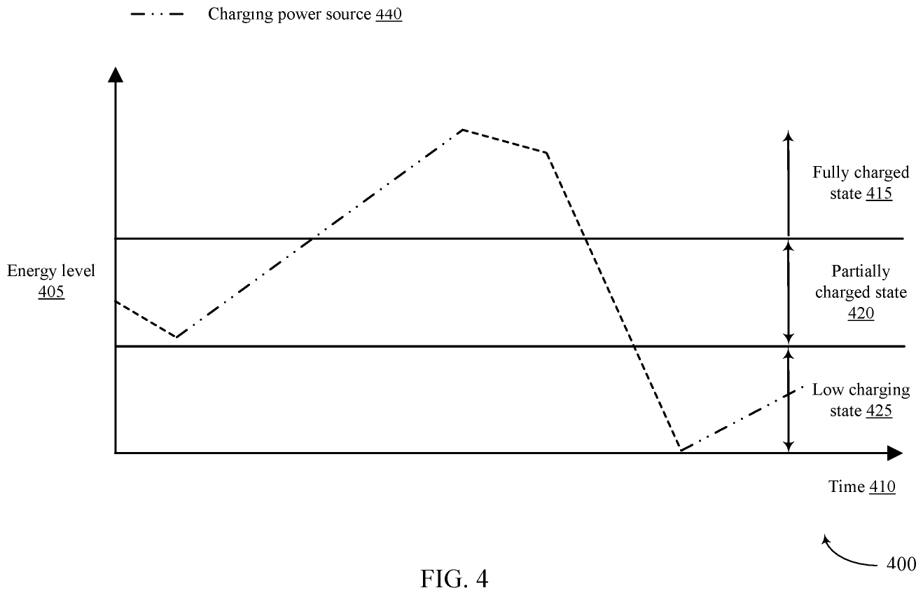

FIG. 4 illustrates an example of an energy level diagram 400 that supports wake up procedures in accordance with one or more aspects of the present disclosure. In some examples, the energy level diagram 400 may implement or be implemented by aspects of the wireless communications systems 100 and 200 as described with reference to FIGS. 1 and 2, respectively. For example, the energy level diagram 400 may be implemented by a UE 115, which may be an example of a UE 115 as described with reference to FIGS. 1, 2, and 3, respectively. Some operations may be omitted from the energy level diagram 400, and other operations may be added to the energy level diagram 400.

The energy level diagram 400 may illustrate a change to an energy level 405 of the UE 115 over time 410, as well as a set of energy states (e.g., activity states) which may be associated with the energy level 405. The UE 115 may occupy a first energy state referred to as a fully charged state (FCS) 415, a second energy state referred to as a partially charged state (PCS) 420, or a third energy state referred to as a low charging state (LCS) 425. In accordance with the set of energy states (e.g., the FCS 415, the PCS 420, the LCS 425, or any combination thereof), the UE 115 may determine an energy state of the UE 115 based on the energy level 405. In some examples, the UE 115 may indicate the energy state within the WUN 320 (as described with reference to FIG. 3) by multiplexing an uplink channel (e.g., a PUCCH, a PUSCH, or both) and control information or data, or by utilizing a MAC-CE or user assistant information (UAI). Additionally or alternatively, the network may determine the energy state of the UE 115 based on the energy level 405 of the UE 115. Based on the determined energy state, the network may determine a maximum BSR that the UE 115 may send the pending data using a minimum amount of power per resource block and a resource block allocation.

The energy level diagram 400 also illustrates discharging power source 430 when the UE 115 is not harvesting energy. The energy level 405 may decrease over the time 410 in which the UE 115 is not harvesting energy. The energy level diagram 400 also illustrates charging power source 440 when the UE 115 is harvesting energy. As shown, the energy level 405 may increase over the time 410 in which the UE 115 is harvesting energy. In some cases, the UE 115 may switch between the FCS 415, the PCS 420, and the LCS 425 in accordance with the energy level 405. For example, the UE 115 may switch from the LCS 425 to the PCS 420 if the UE 115 accumulates sufficient energy to surpass the energy level 405 which separates the LCS 425 from the PCS 420. Alternatively, the UE 115 may switch from the FCS 415 to the PCS 420 if the UE 115 discharges sufficient energy to decline past the energy level 405 of the UE 115 which separates the FCS 115 from the PCS 420.

The FCS 415, the PCS 420, and the LCS 425 may each be associated with a different UE behavior. A UE 115 operating in the FCS 415 may correspond to a power source (e.g., a battery) of the UE 115 being in a fully charged state. When operating in the FCS 415, the UE 115 may support normal operations, for example, wireless communications (e.g., data transmission, data reception, among other examples). In some examples, when operating in the FCS 415, the UE 115 may monitor a PDCCH for downlink data reception from the network, or perform uplink transmission on a PUCCH, a PUSCH, or both. Additionally, when operating in the FCS 415, the UE 115 may transmit an energy level notification to the network (e.g., a network entity 105 or other network entity), to another communication device (e.g., another UE 115), or both within a WUN as described herein. In some examples, the energy level notification may be periodic or aperiodic. Additionally or alternatively, the energy level notification may be event-driven. For example, the UE 115 may transmit the energy level notification based on one or more conditions, such as based on a discharge rate of the UE 115 (e.g., when the discharge rate is above a threshold). When operating in a DRX mode and operating in the FCS 415, the UE 115 may wake up during an ON duration of a DRX cycle as described herein. Alternatively, when operating in a DRX mode and operating in the FCS 415, the UE 115 may skip one or more ON durations of one or more DRX cycles based on reception or decoding of a WUI 315 as described herein.

A UE 115 operating in the PCS 420 may correspond to a power source (e.g., a battery) of the UE 115 being in a partially charged state. The PCS 420 may include a subset of energy states. For instance, K energy states may represent a battery status of the UE 115 when operating in the PCS 420. In some examples, the UE 115 may operate differently in accordance with each of the K energy states. When operating in the PCS 420, the UE 115 may be unable to support wireless communications (e.g., data reception, data transmission) with the network (e.g., a network entity 105 or other network entity) or other communication device (e.g., other UEs 115). However, the UE 115 may be capable of supporting other operations, such as sharing information about a charging status, a charging wake up time, an expected wake up time, among other examples. In some examples, when operating in the PCS 420, the UE 115 may receive a WUI as descried herein. Alternatively, when operating in the PCS 420, the UE 115 may skip monitoring for a WUI by skipping one or more ON durations of one or more DRX cycles as described herein. In some other examples, when operating in the PCS 420, the UE 115 may continue to support ongoing wireless communications (e.g., data transmission, data reception, or both) during an ON duration of a DRX cycle as described herein. Alternatively, when operating in the PCS 420, the UE 115 may skip one or more ON durations as described herein.

A UE 115 operating in the LCS 425 may correspond to a power source (e.g., a battery) of the UE 115 being in a low charge state. When operating in the LCS 425, the UE 115 may not be reachable for wireless communication by the network (e.g., a network entity 105), by another communication device (e.g., a UE 115), or both due to a low energy level. In some examples, when operating in the LCS 425, the UE 115 may harvest energy to accumulate sufficient energy (e.g., increase a battery level) to support wireless communication with the network or other communication devise (e.g., other UEs 115). While operating in the LCS 425, the UE 115 might not support data reception or data transmission. As such, when operating in the LCS 425, the UE 115 might be unable to receive a WUI from the network (e.g., a network entity 105) or transmit a WUN to the network, or both, as described herein. Additionally or alternatively, when operating in the LCS 425, the UE 115 might be unable to receive a WUI from another communication device (e.g., the UE 115) or transmit a WUN to another communication device, or both, as described herein. Thereby, when operating in the LCS 425, the UE 115 may also skip ON durations of a DRX cycle. In other words, the UE 115 may continue to operate in a low power mode to accumulate sufficient energy to be able to support wireless communications with the network or other communication device (e.g., other UEs 115).

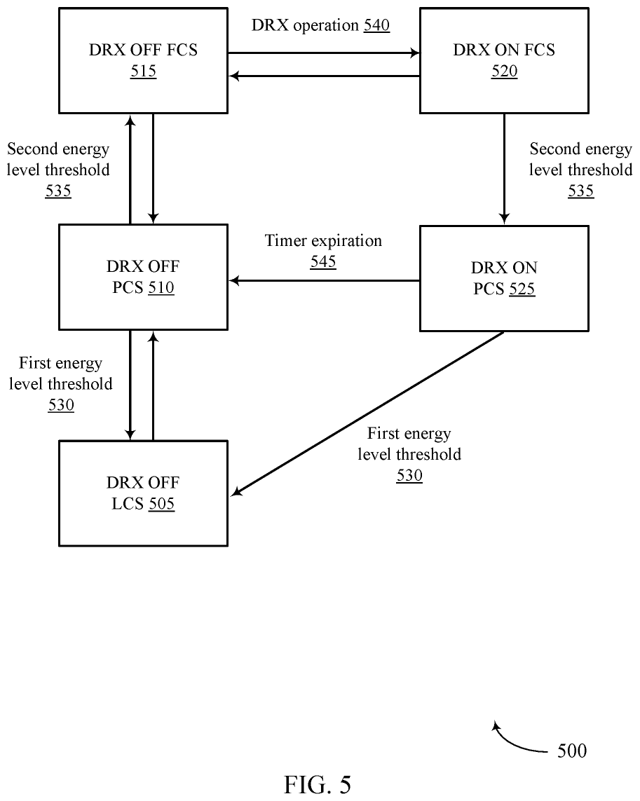

FIG. 5 illustrates an example of an energy state diagram 500 that supports wake up procedures in accordance with one or more aspects of the present disclosure. In some examples, the energy state diagram 500 may implement aspects of the wireless communications systems 100 and 200 as described with reference to FIGS. 1 and 2, respectively. For example, the energy state diagram 500 may be implemented by a UE 115, which may be an example of a UE 115 as described with reference to FIGS. 1 and 2, respectively. Some operations may be omitted from the energy state diagram 500, and other operations may be added to the energy state diagram 500.

The energy state diagram 500 may illustrate an example of how the UE 115 may switch between energy states while operating in a DRX mode. The energy states may include a DRX OFF LCS 505, a DRX OFF PCS 510, a DRX OFF FCS 515, a DRX ON FCS 520, or a DRX ON PCS 525, or any combination thereof. For example, the UE 115 may operate in the DRX OFF LCS 505, where the UE 115 may perform energy harvesting and be inaccessible due to having insufficient accumulated energy (e.g., low battery level). If the energy level of the UE 115 while operating in the DRX OFF PCS 510 falls below a first energy level threshold 530, the UE 115 may switch to operate in the DRX OFF LCS 505. Alternatively, if the energy level of the UE 115 while operating in the DRX OFF LCS 505 exceeds a first energy level threshold 530, the UE 115 may switch to operate in the DRX OFF PCS 510. While in the DRX OFF PCS 510, the UE 115 may be capable of receiving or decoding, or both, the WUI 315 as described with reference to FIG. 3. Additionally, the UE 115 may be capable of transmitting the WUN 320 as described with reference to FIG. 3.

If the energy level of the UE 115 while operating in the DRX OFF PCS 510 exceeds a second energy level threshold 535 that is greater than the first energy level threshold 530, the UE 115 may switch to operate in the DRX OFF FCS 515. When in the DRX OFF FCS 515, the UE 115 may perform a default DRX operation 540 by switching between the DRX OFF FCS 515 and the DRX ON FCS 520 periodically based on a DRX cycle. In some examples, the DRX operation 540 performed by the UE 115 may be a DRX operation associated with 4G systems (e.g., LTE), 5G systems (e.g., NR), sidelink DRX operation, including future systems and radio technologies not explicitly mentioned herein. While in the DRX OFF FCS 515, the UE 115 may be capable of receiving the WUI 315 as described with reference to FIG. 3. Additionally, the UE 115 may be capable of transmitting the WUN 320 as described with reference to FIG. 3. If the energy level of the UE 115 falls below the second energy level threshold 535 while operating in the DRX OFF FCS 515, the UE 115 may switch to operate in the DRX OFF PCS 510.

Alternatively, if the energy level of the UE 115 falls below the second energy level threshold 535 while operating in the DRX ON FCS 520, the UE 115 may switch to operate in the DRX ON PCS 525. In some examples, if the UE 115 is operating in the DRX ON PCS 525, the UE 115 may switch to operate in the DRX OFF PCS 510 based on a timer expiration 545. In some cases, the timer expiration 545 may involve the expiration of an inactivity timer; in other cases, the timer expiration 545 may involve the expiration of a timer for an ON duration. Alternatively, the UE 115 while operating in the DRX ON PCS 525 may switch to operate in the DRX OFF LCS 505 if the energy level of the UE 115 falls below the first energy level threshold 530.

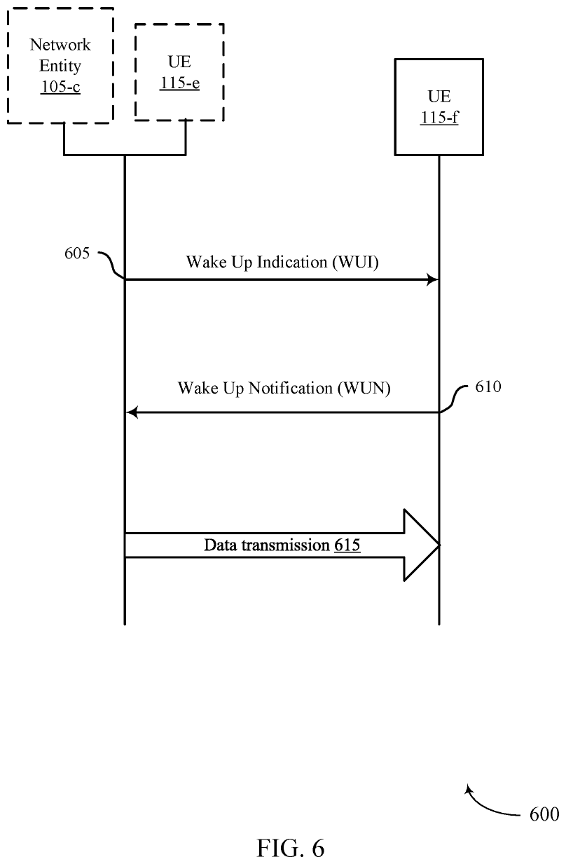

FIG. 6 illustrates an example of a process flow 600 that supports wake up procedures in accordance with one or more aspects of the present disclosure. In some examples, the process flow 600 may implement or be implemented by aspects of the wireless communications systems 100 and 200 as described with reference to FIGS. 1 and 2, respectively. For example, the process flow 600 may be implemented by a network entity 105-c and a UE 115-f, which may be an example of a network entity 105 and a UE 115 as described with reference to FIGS. 1 and 2, respectively. Additionally or alternatively, the process flow 600 may be implemented by a UE 115-e and the UE 115-f, which may be examples of the UEs 115 as described with reference to FIGS. 1 and 2, respectively. The process flow 600 may be implemented by the network entity 105-c, the UE 115-e, or both and the UE 115-f to exchange control signaling to promote power saving at the UE 115-f and efficient reliable communications between the network entity 105-a and the UE 115-f. In the following description of the process flow 600, the operations between the network entity 105-c, the UE 115-e, or both and the UE 115-f may be transmitted in a different order than the example order shown, or the operations performed by the network entity 105-c, the UE 115-e, or both and the UE 115-f may be performed in different orders or at different times. Some operations may also be omitted from the process flow 600, and other operations may be added to the process flow 600.

At 605, the network entity 105-c, the UE 115-e, or both may transmit (or output), and the UE 115-f may receive (or obtain), a WUI on a downlink control channel (e.g., a PDCCH). The UE 115-f may receive the WUI during a first inactive duration and before a first active duration of a DRX cycle. In some examples, the WUI may indicate buffered data at the network entity 105-c, the UE 115-e, or both for transmission to the UE 115-f. Additionally, the WUI may indicate a request for a capability of the UE 115-f to wake up and receive the data transmission during the first active duration.

At 610, the UE 115-f may transmit, and the network entity 105-c, the UE 115-e, or both may receive, a WUN on an uplink control channel (e.g., a PUCCH). In some cases, the UE 115-f may multiplex an uplink channel with control information or data. Similar to the WUI, the UE 115-f may transmit the WUN during the first inactive duration and before the first active duration of a DRX cycle. The WUN may indicate the capability of the UE 115-f to wake up and receive the data transmission during the first active duration associated with the DRX cycle. For example, the WUN may indicate that the UE 115-f has sufficient accumulated energy to wake up and receive the data transmission or to send a data transmission. Alternatively, the WUN may indicate that the UE 115-f may continue to sleep (e.g., operate in a low power mode) and harvest energy until an indicated time interval (e.g., a number of DRX cycles, or other suitable temporal period). At 615, the network entity 105-c, the UE 115-e, or both may transmit (or output), and the UE 115-f may receive, the data transmission. In some examples, the UE 115-f may receive the data transmission during the first active duration of the DRX cycle.

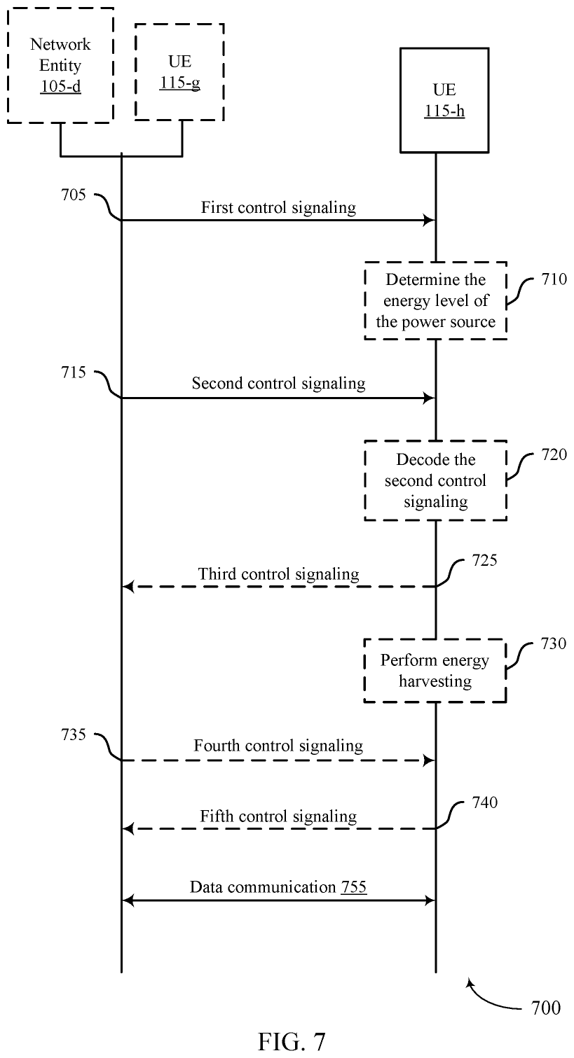

FIG. 7 illustrates an example of a process flow 700 that supports wake up procedures in accordance with one or more aspects of the present disclosure. In some examples, the process flow 700 may implement aspects of the wireless communications systems 100 and 200 as described with reference to FIGS. 1 and 2, respectively. For example, the process flow 700 may be implemented by a network entity 105-d and a UE 115-h, which may be an example of a network entity 105 and a UE 115 as described with reference to FIGS. 1 and 2, respectively. Additionally or alternatively, the process flow 700 may be implemented by a UE 115-g and the UE 115-h, which may be examples of the UEs 115 as described with reference to FIGS. 1 and 2, respectively. The process flow 700 may be implemented by the network entity 105-d and the UE 115-h, the UE 115-g and the UE 115-h, or both to exchange control signaling when the UE 115-h operates in a DRX mode. In the following description of the process flow 700, the operations between the network entity 105-d and the UE 115-h may be transmitted in a different order than the example order shown, or the operations performed by the network entity 105-d and the UE 115-h may be performed in different orders or at different times. Additionally or alternatively, the operations between the UE 115-g and the UE 115-h may be transmitted in a different order than the example order shown, or the operations performed by the UE 115-g and the UE 115-h may be performed in different orders or at different times. Some operations may also be omitted from the process flow 700, and other operations may be added to the process flow 700.

At 705, the network entity 105-d may transmit (or output), and the UE 115-h may receive (or obtain), a first control signaling. Additionally or alternatively, at 705, the UE 115-g may transmit (or output), and the UE 115-h may receive (or obtain), the first control signaling. The first control signaling may indicate a DRX configuration. In some examples, the DRX configuration may include a set of active durations and a set of inactive durations associated with a set of DRX cycles. Based on receiving the first control signaling indicating the DRX configuration, the UE 115-h may operate in a DRX mode.

At 710, the UE 115-h may determine the energy of the power source associated with the UE 115-h. The amount of energy stored within the power source may vary due to the variable charging rate of the UE 115-h as well as the variable access to external sources of energy (e.g., solar energy, thermal energy, vibrational energy, RF energy, etc.) for energy harvesting. Accordingly, the UE 115-h may determine the current energy level of a rechargeable power source associated with the UE 115-h.

At 715, the network entity 105-d may transmit (or output), and the UE 115-h may receive (or obtain), a second control signaling which may include a WUI. Additionally or alternatively, at 715, the UE 115-g may transmit (or output), and the UE 115-h may receive (or obtain), the second control signaling which may include the WUI. The UE 115-h may receive the WUI during an inactive duration which precedes an active duration associated with a first DRX cycle. The WUI timing may depend on the DRX configuration indicated within the first control signaling. In some examples, the WUI may indicate that the network entity 105-d, the UE 115-g, or both has pending data and also a request for feedback from the UE 115-h. That is, the network entity 105-d, the UE 115-g, or both may request feedback from the UE 115-h including an indicated capability for the UE 115-h to receive the pending data during the first active duration. Additionally, the requested feedback may include an energy level of a power source associated with the UE 115-h. The WUI may also include a set of reference signals to aid the UE 115-h to determine the pathloss. In some examples, the UE 115-h may receive the WUI based on the energy level of the power source associated with the UE 115-h. The UE 115-h may receive the WUI by monitoring for the WUI.

At 720, the UE 115-h may decode the WUI based on the energy level of the power source associated with the UE 115-h. For example, the UE 115-h may decode the WUI based on a comparison between the energy level of the power source associated with the UE 115-h and an energy threshold. If the energy level of the power source satisfies the energy threshold, the UE 115-h may decode the WUI. Alternatively, the UE 115-h may refrain from decoding the WUI based on the energy level of the power source being below the energy threshold. Based on the WUI, the UE 115-h may determine a payload associated with pending data. For instance, the UE 115-h may determine the amount of data in the pending data that is buffered at the network entity 105-d, the UE 115-g, or both. Additionally, the UE 115-h may estimate a pathloss value based on the WUI. For example, the UE 115-h may determine the latest or most recent pathloss value which may be used to allocate power for uplink communications. In some examples, the UE 115-h may estimate the pathloss value based on demultiplexing the set of reference signals associated with the WUI.

At 725, the UE 115-h may transmit, and the network entity 105-d may receive, a third control signaling which may be referred to as a WUN. Additionally or alternatively, at 725, the UE 115-h may transmit, and the UE 115-g may receive, the third control signaling which may be referred to as the WUN. The UE 115-h may receive the WUN during the first inactive duration which precedes the first active duration associated with the first DRX cycle. The WUN may indicate the capability of the UE 115-h to receive pending data during the first active duration of the first DRX cycle. Additionally, the WUN may indicate the energy level of the power source associated with the UE 115-h. The UE 115-h may indicate an energy state associated with the UE 115-h. The UE 115-h may transmit the WUN based on a comparison between the energy level of the power source and a threshold. For example, the UE 115-h may transmit the WUN if the energy level of the power source satisfies the threshold. Alternatively, the UE 115-h may refrain from transmitting the WUN if the energy level of the power source is below the threshold. The threshold for comparison used to determine if the UE 115-h may transmit the WUN may be different from the energy threshold used to determine if the UE 115-h may transmit the WUI. In some examples, the UE 115-h may transmit the WUN based on the pathloss value as well as the energy level of the power source associated with the UE 115-h.

In some examples, the WUN may indicate a time interval for energy harvesting to be performed by the UE 115-h. The time interval may include one or more DRX cycles of the set of DRX cycles which succeed the first DRX. In some examples, the indicated time interval within the WUN may notify the network entity 105-d, the UE 115-g, or both that the UE 115-h will go offline and occupy a sleep state for X cycles (or X seconds). For example, the UE 115-h may indicate that the UE 115-h may skip X cycles of wireless communication and instead use the X cycles for energy accumulation. Accordingly, the network entity 105-d, the UE 115-g, or both may avoid unnecessary data buffering and inform others that the UE 115-h will not be reachable for the indicated time interval. By indicating the time interval in which the UE 115-h will be unreachable, the network entity 105-d, the UE 115-g, or both may prevent wasting network resources as well as the loss of data transmissions.

In some cases, the WUN may indicate the maximum number of transport blocks, the maximum number of bits, or both, which may be decodable by the UE 115-h during the first active duration of the first DRX cycle. In some examples, the UE 115-h may indicate an overhead of each transport block reception which may be associated with receiving a downlink transmission such as the pending data at the network entity 105-d. In other examples, the UE 115-h may indicate an overhead of each transport block reception which may be associated with receiving a sidelink transmission such as the pending data at the UE 115-g. Additionally or alternatively, the UE 115-h may indicate an overhead of each transport block transmission which may be associated with transmitting an uplink transmission. Additionally or alternatively, the UE 115-h may indicate an overhead of each transport block transmission which may be associated with transmitting a sidelink transmission. In some examples, the WUN may indicate a per-resource power level associated with the UE 115-h. The WUN may also indicate a BSR, a power headroom report, or both, by indicating power, energy units, or total energy associated with a set of energy units.

At 730, the UE 115-h may perform energy harvesting. For example, the UE 115-h may harvest energy during the time interval indicated in the WUN by accumulating solar energy, thermal energy, vibrational energy, RF energy, or any combination thereof. At 735, the network entity 105-d may transmit, and the UE 115-h may receive, a fourth control signaling carrying a WUI (e.g., a second WUI). Additionally or alternatively, at 735, the UE 115-g may transmit, and the UE 115-h may receive, the fourth control signaling carrying the WUI (e.g., the second WUI). Based on the time interval indicated in the WUI carried by the second control signaling, the UE 115-h may receive the second WUI before a second active duration associated with a second DRX cycle. Similar to the WUI carried in the second control signaling, the second WUI may indicate the pending data. However, the second WUI may also indicate the request for the capability of the UE 115-h to receive the pending data during the second active duration of the second DRX cycle. Additionally, the second WUI may indicate a configuration comprising of a set of energy states which may be associated with the UE 115-h. In some examples, the UE 115-h may determine an energy state of the UE 115-h based on the set of energy states and the energy level of the power source associated with the UE.

At 740, the UE 115-h may transmit, and the network entity 105-d may receive, a fifth control signaling which may be referred to as a second WUN. Additionally or alternatively, at 740, the UE 115-h may transmit, and the UE 115-g may receive, the fifth control signaling which may be referred to as the second WUN. The UE 115-h may receive the second WUN during the second inactive period preceding the second active duration of the second DRX cycle. The second WUN may indicate the capability of the UE 115-h to receive the pending data during the second active duration of the second DRX cycle. Additionally, the second WUN may indicate the energy level of the power source associated with the UE 115-h

At 755, the UE 115-h and the network entity 105-d may communicate data. Additionally or alternatively, at 755, the UE 115-g and the UE 115-h may communicate data. For example, the network entity 105-d, the UE 115-g, or both may send, and the UE 115-h may receive, the pending data during the first active duration of the first DRX cycle. Alternatively, the network entity 105-d, the UE 115-g, or both may send, and the UE 115-h may receive, the pending data during the second active duration of the second DRX cycle. The UE 115-h and the network entity 105-d, the UE 115-g, or both may communicate data based on the third control signaling and the energy level of the power source associated with the UE 115-h. Additionally or alternatively, the UE 115-h and the network entity 105-d, the UE 115-g, or both may communicate data based on the fifth control signaling and the energy level of the power source associated with the UE 115-h.

FIG. 8 shows a block diagram 800 of a device 805 that supports wake up procedures in accordance with one or more aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to wake up procedures). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to wake up procedures). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of wake up procedures as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a first device (e.g., the device 805) in accordance with examples as disclosed herein. For example, the communications manager 820 may be configured as or otherwise support a means for receiving, from a second device (e.g., a network entity 105, a UE 115), first control signaling indicating a DRX configuration associated with a set of DRX cycles. The communications manager 820 may be configured as or otherwise support a means for receiving, from the second device, second control signaling during a first inactive duration and before a first active duration associated with a first DRX cycle of the set of DRX cycles, the second control signaling indicating that the second device has pending data for the first device (e.g., a UE 115), the second control signaling further including a request for feedback from the first device, the feedback indicating a capability for the first device to receive the pending data from the network entity during the first active duration and an energy level of a power source associated with the first device. The communications manager 820 may be configured as or otherwise support a means for communicating with the network entity based on the second control signaling.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for power saving.

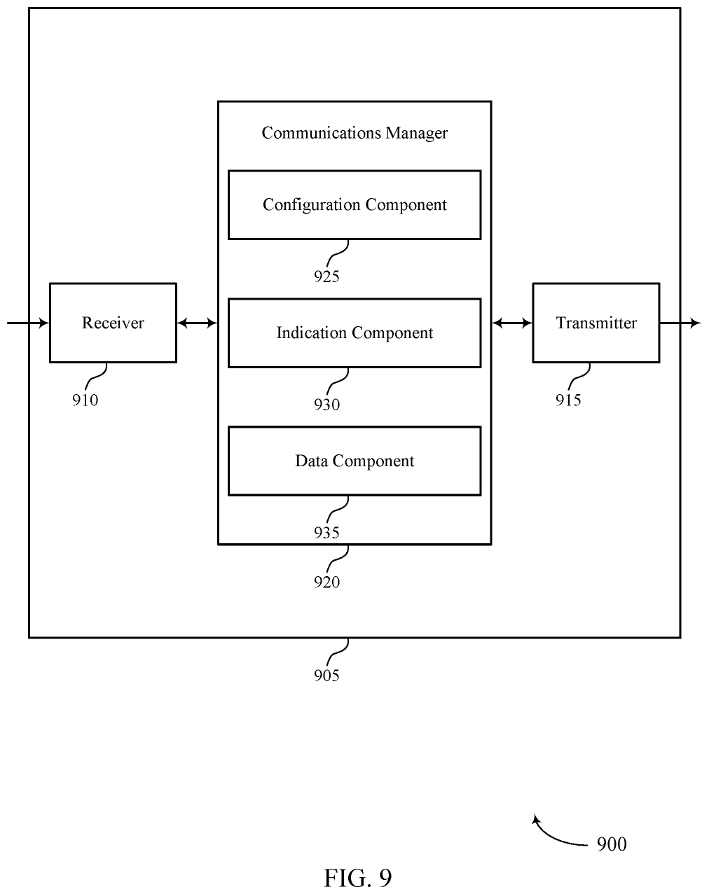

FIG. 9 shows a block diagram 900 of a device 905 that supports wake up procedures in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to wake up procedures). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to wake up procedures). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of wake up procedures as described herein. For example, the communications manager 920 may include a configuration component 925, an indication component 930, a data component 935, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a first device (e.g., the device 905) in accordance with examples as disclosed herein. The configuration component 925 may be configured as or otherwise support a means for receiving, from a second device (e.g., a network entity 105, a UE 115), first control signaling indicating a DRX configuration associated with a set of DRX cycles. The indication component 930 may be configured as or otherwise support a means for receiving, from the second device, second control signaling during a first inactive duration and before a first active duration associated with a first DRX cycle of the set of DRX cycles, the second control signaling indicating that the second device has pending data for the first device, the second control signaling further including a request for feedback from the first device, the feedback indicating a capability for the first device to receive the pending data from the second device during the first active duration and an energy level of a power source associated with the first device. The data component 935 may be configured as or otherwise support a means for communicating with the second device based on the second control signaling.

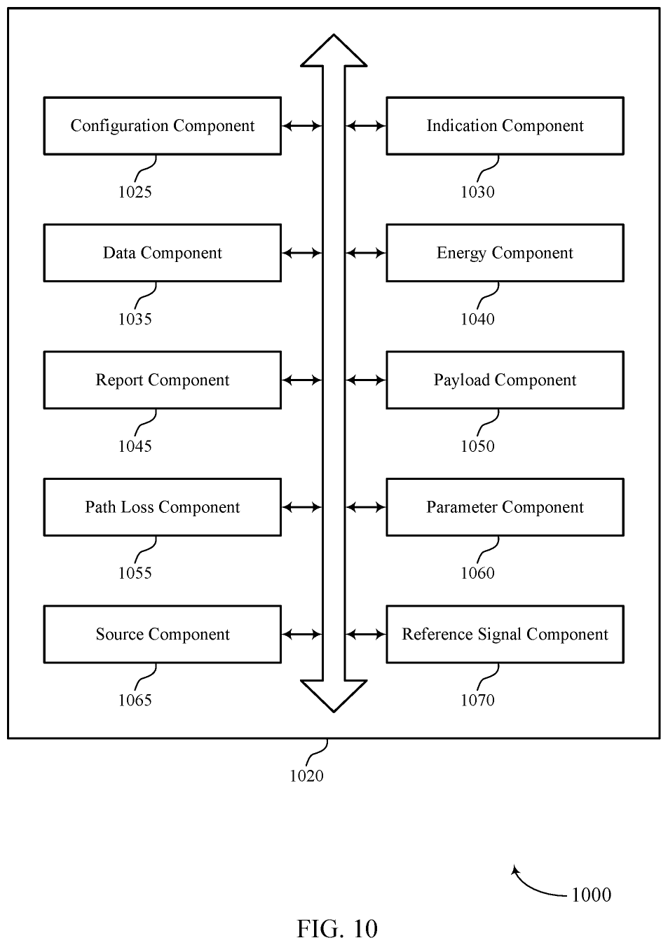

FIG. 10 shows a block diagram 1000 of a communications manager 1020 that supports wake up procedures in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of wake up procedures as described herein. For example, the communications manager 1020 may include a configuration component 1025, an indication component 1030, a data component 1035, an energy component 1040, a report component 1045, a payload component 1050, a path loss component 1055, a parameter component 1060, a source component 1065, a reference signal component 1070, or any combination thereof. Each of these components may communicate, directly or indirectly, with one another (e.g., via one or more buses).

The communications manager 1020 may support wireless communication at a first device (e.g., the device 805, the device 905, or the device 1105) in accordance with examples as disclosed herein. The configuration component 1025 may be configured as or otherwise support a means for receiving, from a second device (e.g., a network entity 105, a UE 115), first control signaling indicating a DRX configuration associated with a set of DRX cycles. The indication component 1030 may be configured as or otherwise support a means for receiving, from the second device, second control signaling during a first inactive duration and before a first active duration associated with a first DRX cycle of the set of DRX cycles, the second control signaling indicating that the second device has pending data for the first device (e.g., a UE 115), the second control signaling further including a request for feedback from the first device, the feedback indicating a capability for the first device to receive the pending data from the second device during the first active duration and an energy level of a power source associated with the first device. The data component 1035 may be configured as or otherwise support a means for communicating with the second device based on the second control signaling.

In some examples, the indication component 1030 may be configured as or otherwise support a means for transmitting, to the second device, third control signaling during the first inactive duration and before the first active duration associated with the first DRX cycle, the third control signaling indicating the capability for the first device to receive the pending data from the second device during the first active duration associated with the first DRX cycle, and the energy level of the power source associated with the first device. In some examples, the energy component 1040 may be configured as or otherwise support a means for determining the energy level of the power source associated with the first device. In some examples, the energy component 1040 may be configured as or otherwise support a means for receiving, from the second device, the second control signaling further based on the energy level of the power source associated with the first device. In some examples, the energy component 1040 may be configured as or otherwise support a means for transmitting, to the second device, the third control signaling further based on the energy level of the power source associated with the first device.

In some examples, to support communicating with the second device, the data component 1035 may be configured as or otherwise support a means for receiving the pending data during the first active duration associated with the first DRX cycle based on the third control signaling and the energy level of the power source associated with the first device. In some examples, the indication component 1030 may be configured as or otherwise support a means for decoding the second control signaling based on the energy level of the power source associated with the first device satisfying an energy threshold. In some examples, the indication component 1030 may be configured as or otherwise support a means for transmitting, to the second device, the third control signaling further based on the decoded second control signaling.

In some examples, the indication component 1030 may be configured as or otherwise support a means for monitoring for the second control signaling, and the indication component 1030 may be configured as or otherwise support a means for refraining from decoding the second control signaling based on the energy level of the power source associated with the first device being below an energy threshold. In some examples, transmitting, to the second device, the third control signaling is further based on the energy level of the power source associated with the first device satisfying a threshold.

In some examples, the indication component 1030 may be configured as or otherwise support a means for monitoring for the second control signaling during the first inactive duration and before the first active duration associated with the first DRX cycle of the set of DRX cycles based on the energy level of the power source associated with the apparatus satisfying the threshold. In some examples, the indication component 1030 may be configured as or otherwise support a means for transmitting, to the network entity, the third control signaling during the first inactive duration and before the first active duration associated with the first DRX cycle based on the energy level of the power source associated with the apparatus satisfying the threshold. In some examples, the first inactive duration is based on a charging rate and a time for the energy level of the power source associated with the apparatus to satisfy the threshold

In some examples, the indication component 1030 may be configured as or otherwise support a means for refraining to monitor for the second control signaling during the first inactive duration and before the first active duration associated with the first DRX cycle of the set of DRX cycles based on the energy level of the power source associated with the apparatus satisfying the threshold. In some examples, the indication component 1030 may be configured as or otherwise support a means for refraining to transmit the third control signaling during the first inactive duration and before the first active duration associated with the first DRX cycle based on the energy level of the power source associated with the apparatus satisfying the threshold.

In some examples, the indication component 1030 may be configured as or otherwise support a means for refraining to monitor for the second control signaling during the first inactive duration and before the first active duration associated with the first DRX cycle of the set of DRX cycles based on the energy level of the power source associated with the apparatus satisfying the threshold. In some examples, the indication component 1030 may be configured as or otherwise support a means for transmitting the third control signaling during the first inactive duration and before the first active duration associated with the first DRX cycle based on the energy level of the power source associated with the apparatus satisfying the threshold.

In some examples, the third control signaling indicates a time interval for energy harvesting at the first device, and the source component 1065 may be configured as or otherwise support a means for charging the power source associated with the first device based on the time interval, the time interval including one or more DRX cycles of the set of DRX cycles following the first DRX cycle based on the time interval for energy harvesting at the first device, and where charging the power source associated with the first device is further based on accumulating solar energy, thermal energy, vibrational energy, radio frequency energy, or any combination thereof.

In some examples, the indication component 1030 may be configured as or otherwise support a means for receiving, from the second device, fourth control signaling during a second inactive duration before a second active duration associated with a second DRX cycle for the wireless communication based on the time interval, the fourth control signaling indicating the pending data associated with the wireless communication and the request for the capability of the first device to receive the pending data during the second active duration associated with the second DRX cycle. In some examples, the indication component 1030 may be configured as or otherwise support a means for transmitting, to the second device, fifth control signaling during the second inactive duration before the second active duration associated with the second DRX cycle, the fifth control signaling indicating the capability of the first device to receive the pending data during the second active duration associated with the second DRX cycle, the capability indicating the energy level of the power source associated with the first device. In some examples, the data component 1035 may be configured as or otherwise support a means for receiving the pending data during the second active duration associated with the second DRX cycle based on the fifth control signaling and the energy level of the power source associated with the first device.

In some examples, the payload component 1050 may be configured as or otherwise support a means for determining a payload associated with the pending data based on the second control signaling. In some examples, the indication component 1030 may be configured as or otherwise support a means for transmitting, to the second device, the third control signaling further based on the payload associated with the pending data and the energy level of the power source associated with the first device. In some examples, the path loss component 1055 may be configured as or otherwise support a means for determining a path loss value based on the second control signaling. In some examples, the indication component 1030 may be configured as or otherwise support a means for transmitting, to the second device, the third control signaling further based on the path loss value and the energy level of the power source associated with the first device. In some examples, the reference signal component 1070 may be configured as or otherwise support a means for demultiplexing a set of reference signals associated with the second control signaling. In some examples, the path loss component 1055 may be configured as or otherwise support a means for determining the path loss value further based on the demultiplexed set of reference signals associated with the second control signaling.

In some examples, the payload component 1050 may be configured as or otherwise support a means for determining a maximum number of transport blocks or a maximum number of bits, or both, decodable by the first device during the first active duration of the first DRX cycle. In some examples, the third control signaling indicates the maximum number of transport blocks or the maximum number of bits, or both, decodable by the first device during the first active duration of the first DRX cycle. In some examples, the third control signaling indicates an overhead of each transport block transmission or reception associated with receiving a downlink transmission or transmitting an uplink transmission, or both.

In some examples, the payload component 1050 may be configured as or otherwise support a means for determining a transport block size associated with the pending data. In some examples, the parameter component 1060 may be configured as or otherwise support a means for determining a resource allocation or a MCS associated with the pending data, or both, based on the transport block size associated with the pending data. In some examples, the data component 1035 may be configured as or otherwise support a means for communicating with the second device further based on the resource allocation or the MCS associated with the pending data, or both. In some examples, the third control signaling indicates a per-resource power level associated with the first device, or a number of DRX cycles to skip the wireless communication with the first device, or both.

In some examples, the configuration component 1025 may be configured as or otherwise support a means for receiving fourth control signaling indicating a configuration including a set of energy states. In some examples, the energy component 1040 may be configured as or otherwise support a means for determining an energy state associated with the set of energy states of the first device based on the energy level of the power source associated with the first device. In some examples, the indication component 1030 may be configured as or otherwise support a means for receiving, from the second device, the second control signaling further based on the energy state. In some examples, the indication component 1030 may be configured as or otherwise support a means for transmitting, to the second device, the third control signaling further based on the energy state.

In some examples, the set of energy states includes a first energy state associated with a first energy level, a second energy state associated with a second energy level, a third energy state associated with a third energy level, or any combination thereof. In some examples, the first energy level is greater than the second energy level and the third energy level. In some examples, the second energy level is greater than the third energy level. In some examples, the second energy state includes a subset of energy states.

In some examples, the energy component 1040 may be configured as or otherwise support a means for transmitting, to the second device, third control signaling indicating the capability for the first device to receive the pending data from the second device based on a condition, the energy level of the power source associated with the first device, an energy state associated with the first device, or a periodicity reporting of an energy level of the power source associated with the first device, or any combination thereof. In some examples, the report component 1045 may be configured as or otherwise support a means for transmitting to the second device, third control signaling including a BSR or a power headroom report, or both, indicating power, energy units, or total energy associated with a set of energy units. In some examples, an energy level of the power source associated with the first device corresponds to an energy state of the first device, a maximum uplink BSR associated with the first device, a maximum number of BSR bits associated with the first device, or any combination thereof.

In some examples, the indication component 1030 may be configured as or otherwise support a means for transmitting, to the second device, third control signaling during the first inactive duration before the first active duration associated with the first DRX cycle, the third control signaling indicating the capability for the first device to receive the pending data from the second device during the first active duration associated with the first DRX cycle and the energy level of the power source associated with the first device. In some examples, the third control signaling indicates an energy state associated with the first device, and where the third control signaling includes an uplink channel multiplexed with control information or data.

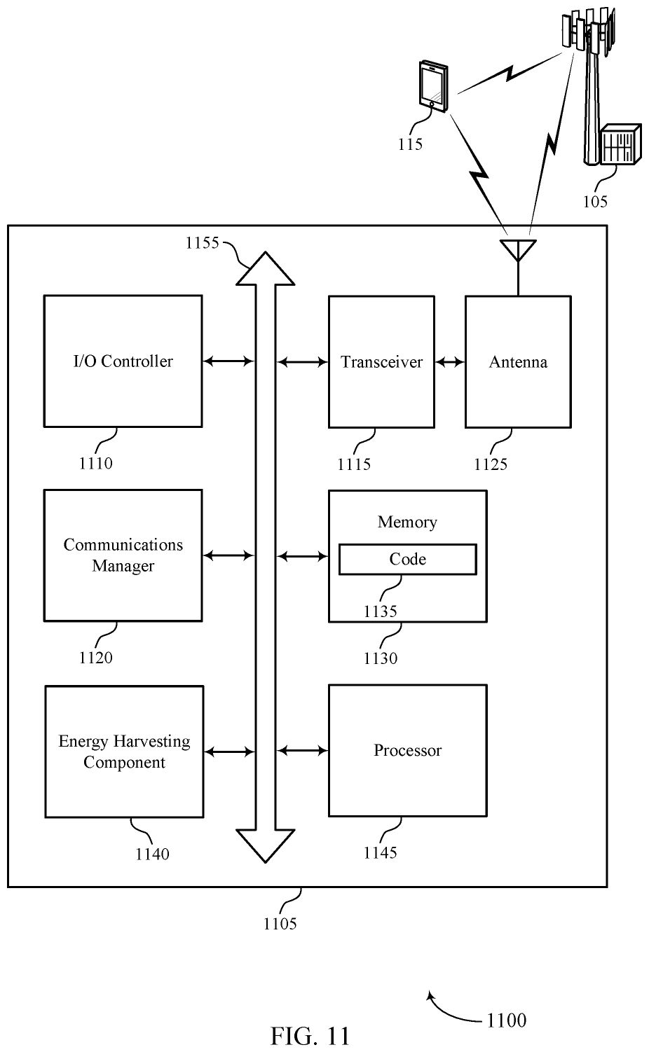

FIG. 11 shows a diagram of a system 1100 including a device 1105 that supports wake up procedures in accordance with one or more aspects of the present disclosure. The device 1105 may be an example of or include the components of a device 805, a device 905, or a UE 115 as described herein. The device 1105 may communicate wirelessly with one or more network entities 105, UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, an energy harvesting component 1140, and a processor 1145. These components may be in electronic communication or otherwise coupled (e.g., operatively, communicatively, functionally, electronically, electrically) via one or more buses (e.g., a bus 1155).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1145. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1145, cause the device 1105 to perform various functions described herein. The code 1135 may be stored in a non-transitory computer-readable medium such as system memory or another type of memory. In some cases, the code 1135 may not be directly executable by the processor 1145 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The energy harvesting component 1140 may include an energy harvesting circuit chips. The circuitry may include one or multiple circuit elements, such as resistors, transistors, capacitors, inductors, amplifiers, diodes, among other examples, that may be coupled (e.g., operatively, communicatively, functionally, electronically, or electrically) with each other to support energy harvesting operations at the device 1105, or any combination thereof. The circuitry may receive energy from one or more external energy sources and may process (e.g., collect, convert, transform) the energy via the one or multiple circuit elements, such as resistors, transistors, capacitors, inductors, amplifiers, diodes, among other examples, to charge a power source of the device 1105.

In some cases, the energy harvesting component 1140 may include RF energy harvesting circuits and active RF components. Additionally or alternatively, the energy harvesting component 1140 may include solar cells. In some cases, the energy harvesting component 1140 may include one or more rechargeable batteries with the capability of performing energy harvesting operations in which the one or more rechargeable batteries may be charged with external energy sources (e.g., solar energy, thermal energy, RF energy, etc.). In some cases, the energy harvesting component 1140 may include passive IoT (e.g., RF identifier ID (RFID) tags) with one or more rechargeable batteries and/or one or more storage units (e.g., supercapacitors) where the RFID may be equipped with a wakeup receiver (e.g., such as the transceiver 1115). In some examples, the wakeup receiver may perform monitoring for a wake up indicator (e.g., a WUI as described herein with reference to FIGS. 2 through 7) and a wake up notification (e.g., a WUN as described herein with reference to FIGS. 2 through 7). Additionally or alternatively, the wakeup receiver may perform command and/or query processing as well as backscattering during the ON durations of a DRX cycle (e.g., ON duration 310).

The processor 1145 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1145 may be configured to operate a memory array using a memory controller. In some other cases, a memory controller may be integrated into the processor 1145. The processor 1145 may be configured to execute computer-readable instructions stored in a memory (e.g., the memory 1130) to cause the device 1105 to perform various functions (e.g., functions or tasks supporting wake up procedures). For example, the device 1105 or a component of the device 1105 may include a processor 1145 and memory 1130 coupled with or to the processor 1145, the processor 1145 and memory 1130 configured to perform various functions described herein.

The communications manager 1120 may support wireless communication at a device (e.g., the device 1105) in accordance with examples as disclosed herein. For example, the communications manager 1120 may be configured as or otherwise support a means for receiving, from a network entity, first control signaling indicating a DRX configuration associated with a set of DRX cycles. The communications manager 1120 may be configured as or otherwise support a means for receiving, from the network entity, second control signaling during a first inactive duration and before a first active duration associated with a first DRX cycle of the set of DRX cycles, the second control signaling indicating that the network entity (or another network entity or another UE) has pending data for the device (e.g., a UE 115), the second control signaling further including a request for feedback from the device, the feedback indicating a capability for the device to receive the pending data from the network entity during the first active duration and an energy level of a power source associated with the device. The communications manager 1120 may be configured as or otherwise support a means for communicating with the network entity based on the second control signaling.

By including or configuring the communications manager 1120 in accordance with examples as described herein, the device 1105 may support techniques for longer battery life.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1145, the memory 1130, the code 1135, or any combination thereof. For example, the code 1135 may include instructions executable by the processor 1145 to cause the device 1105 to perform various aspects of wake up procedures as described herein, or the processor 1145 and the memory 1130 may be otherwise configured to perform or support such operations.

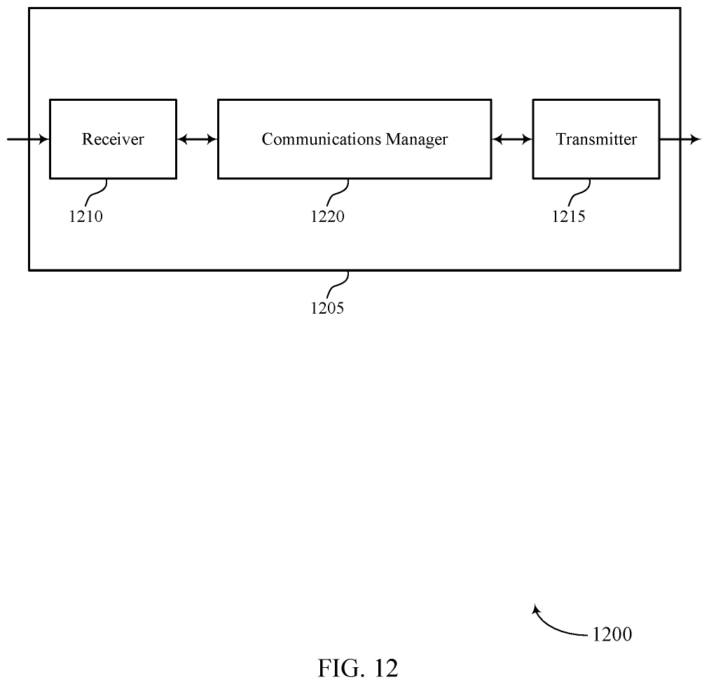

FIG. 12 shows a block diagram 1200 of a device 1205 that supports wake up procedures in accordance with one or more aspects of the present disclosure. The device 1205 may be an example of aspects of a network entity (e.g., a network entity 105, or other network entity as described herein) or a UE (e.g., a UE 115) as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to wake up procedures). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to wake up procedures). In some examples, the transmitter 1215 may be co-located with a receiver 1210 in a transceiver module. The transmitter 1215 may utilize a single antenna or a set of multiple antennas.

The communications manager 1220, the receiver 1210, the transmitter 1215, or various combinations thereof or various components thereof may be examples of means for performing various aspects of wake up procedures as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1220 may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communication at the device 1205 (e.g., a network entity 105, a UE 115) in accordance with examples as disclosed herein. For example, the communications manager 1220 may be configured as or otherwise support a means for outputting first control signaling indicating a DRX configuration associated with a set of DRX cycles. The communications manager 1220 may be configured as or otherwise support a means for outputting second control signaling during a first inactive duration and before a first active duration associated with a first DRX cycle of the set of DRX cycles associated with a second device (e.g., a UE 115), the second control signaling indicating that the first device (e.g., a network entity 105, a UE 115) has pending data for the second device, the second control signaling further including a request for feedback from the second device, the feedback indicating a capability for the second device to receive the pending data from the first device during the first active duration and an energy level of a power source associated with the second device. The communications manager 1220 may be configured as or otherwise support a means for communicating with the second device based on the second control signaling.

By including or configuring the communications manager 1220 in accordance with examples as described herein, the device 1205 (e.g., a processor controlling or otherwise coupled to the receiver 1210, the transmitter 1215, the communications manager 1220, or a combination thereof) may support techniques for more efficient utilization of communication resources.

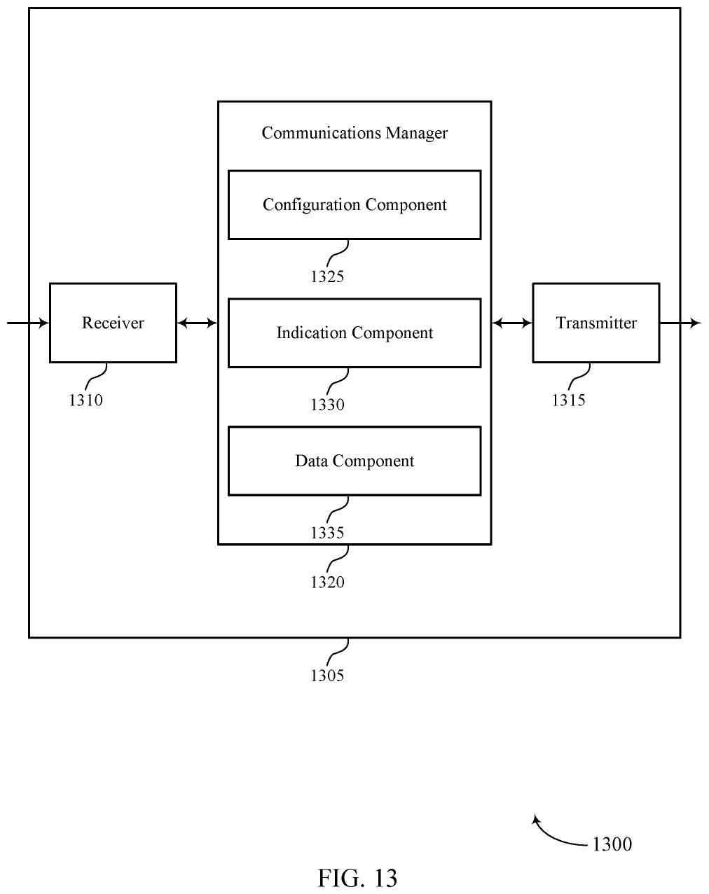

FIG. 13 shows a block diagram 1300 of a device 1305 that supports wake up procedures in accordance with one or more aspects of the present disclosure. The device 1305 may be an example of aspects of a device 1205, a network entity (e.g., a network entity 105, or other network entity as described herein), or a UE (e.g., a UE 115) as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to wake up procedures). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to wake up procedures). In some examples, the transmitter 1315 may be co-located with a receiver 1310 in a transceiver module. The transmitter 1315 may utilize a single antenna or a set of multiple antennas.

The device 1305, or various components thereof, may be an example of means for performing various aspects of wake up procedures as described herein. For example, the communications manager 1320 may include a configuration component 1325, an indication component 1330, a data component 1335, or any combination thereof. The communications manager 1320 may be an example of aspects of a communications manager 1220 as described herein. In some examples, the communications manager 1320, or various components thereof, may be configured to perform various operations (e.g., receiving, monitoring, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to receive information, transmit information, or perform various other operations as described herein.

The communications manager 1320 may support wireless communication at the device 1305 (e.g., the network entity, the UE 115) in accordance with examples as disclosed herein. The configuration component 1325 may be configured as or otherwise support a means for outputting first control signaling indicating a DRX configuration associated with a set of DRX cycles. The indication component 1330 may be configured as or otherwise support a means for outputting second control signaling during a first inactive duration and before a first active duration associated with a first DRX cycle of the set of DRX cycles associated with a device (e.g., the UE 115), the second control signaling indicating that the network entity has pending data for the device, the second control signaling further including a request for feedback from the device, the feedback indicating a capability for the device to receive the pending data from the network entity during the first active duration and an energy level of a power source associated with the device. The data component 1335 may be configured as or otherwise support a means for communicating with the device based on the second control signaling.

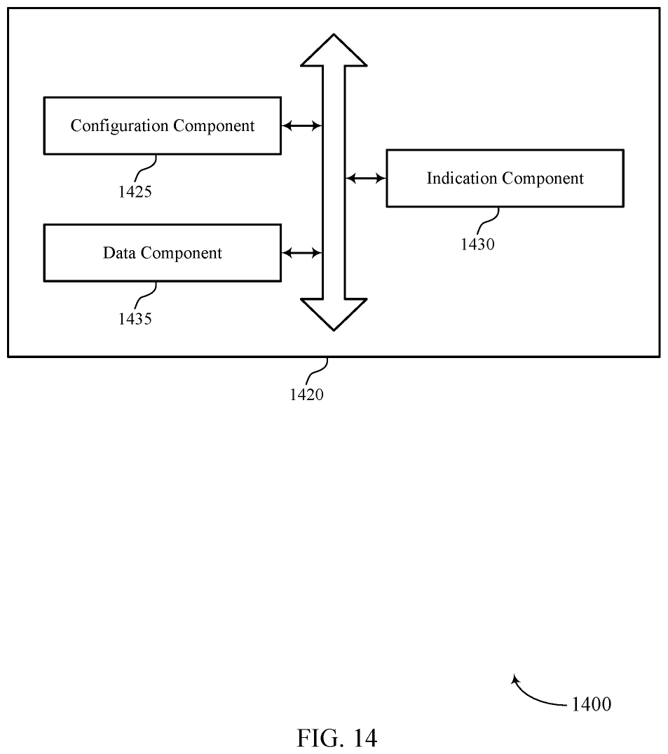

FIG. 14 shows a block diagram 1400 of a communications manager 1420 that supports wake up procedures in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of wake up procedures as described herein. For example, the communications manager 1420 may include a configuration component 1425, an indication component 1430, a data component 1435, or any combination thereof. Each of these components may communicate, directly or indirectly, with one another (e.g., via one or more buses).

The communications manager 1420 may support wireless communication at a network entity, a UE, or both (e.g., the device 1205, the device 1305, or the device 1505) in accordance with examples as disclosed herein. The configuration component 1425 may be configured as or otherwise support a means for outputting first control signaling indicating a DRX configuration associated with a set of DRX cycles. The indication component 1430 may be configured as or otherwise support a means for outputting second control signaling during a first inactive duration and before a first active duration associated with a first DRX cycle of the set of DRX cycles associated with a second device (e.g., a UE 115), the second control signaling indicating that the first device (e.g., a network entity 105, a UE 115) has pending data for the second device, the second control signaling further including a request for feedback from the second device, the feedback indicating a capability for the second device to receive the pending data from the network entity during the first active duration and an energy level of a power source associated with the second device. The data component 1435 may be configured as or otherwise support a means for communicating with the second device based on the second control signaling.

In some examples, the indication component 1430 may be configured as or otherwise support a means for obtaining third control signaling during the first inactive duration and before the first active duration associated with the first DRX cycle, the third control signaling indicating the capability for the second device to receive the pending data from the first device during the first active duration associated with the first DRX cycle and the energy level of the power source associated with the second device.

In some examples, the third control signaling indicates a time interval for energy harvesting at the second device. In some examples, the third control signaling indicates a per-resource power level associated with the second device, or a number of DRX cycles to skip the wireless communication with the second device, or both. In some examples, the third control signaling includes a BSR or a power headroom report, or both, indicating power, energy units, or total energy associated with a set of energy units. In some examples, to support communicating with the second device, the data component 1435 may be configured as or otherwise support a means for outputting the pending data during the first active duration associated with the first DRX cycle based on the third control signaling and the energy level of the power source associated with the second device.

FIG. 15 shows a diagram of a system 1500 including a device 1505 that supports wake up procedures in accordance with one or more aspects of the present disclosure. The device 1505 may be an example of or include the components of a device 1205, a device 1305, a network entity (e.g., a network entity 105, or other network entity as described herein), or a UE 115 as described herein. The device 1505 may communicate wirelessly with one or more network entities 105, UEs 115, or any combination thereof. The device 1505 may include components for bi-directional voice and data communications including components for transmitting and receiving communications, such as a communications manager 1520, a network communications manager 1510, a transceiver 1515, an antenna 1525, a memory 1530, code 1535, a processor 1540, and an inter-station communications manager 1545. These components may be in electronic communication or otherwise coupled (e.g., operatively, communicatively, functionally, electronically, electrically) via one or more buses (e.g., a bus 1550).

The network communications manager 1510 may manage communications with a core network 130 (e.g., via one or more wired backhaul links). For example, the network communications manager 1510 may manage the transfer of data communications for client devices, such as one or more UEs 115.

In some cases, the device 1505 may include a single antenna 1525. However, in some other cases the device 1505 may have more than one antenna 1525, which may be capable of concurrently transmitting or receiving multiple wireless transmissions. The transceiver 1515 may communicate bi-directionally, via the one or more antennas 1525, wired, or wireless links as described herein. For example, the transceiver 1515 may represent a wireless transceiver and may communicate bi-directionally with another wireless transceiver. The transceiver 1515 may also include a modem to modulate the packets, to provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof, as described herein.

The memory 1530 may include RAM and ROM. The memory 1530 may store computer-readable, computer-executable code 1535 including instructions that, when executed by the processor 1540, cause the device 1505 to perform various functions described herein. The code 1535 may be stored in a non-transitory computer-readable medium such as system memory or another type of memory. In some cases, the code 1535 may not be directly executable by the processor 1540 but may cause a computer (e.g., when compiled and executed) to perform functions described herein. In some cases, the memory 1530 may contain, among other things, a BIOS which may control basic hardware or software operation such as the interaction with peripheral components or devices.

The processor 1540 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1540 may be configured to operate a memory array using a memory controller. In some other cases, a memory controller may be integrated into the processor 1540. The processor 1540 may be configured to execute computer-readable instructions stored in a memory (e.g., the memory 1530) to cause the device 1505 to perform various functions (e.g., functions or tasks supporting wake up procedures). For example, the device 1505 or a component of the device 1505 may include a processor 1540 and memory 1530 coupled with or to the processor 1540, the processor 1540 and memory 1530 configured to perform various functions described herein.

The inter-station communications manager 1545 may manage communications with other network entities 105, and may include a controller or scheduler for controlling communications with UEs 115 in cooperation with other network entities 105. For example, the inter-station communications manager 1545 may coordinate scheduling for transmissions to UEs 115 for various interference mitigation techniques such as beamforming or joint transmission. In some examples, the inter-station communications manager 1545 may provide an X2 interface within an LTE/LTE-A wireless communications network technology to provide communication between network entities 105.

The communications manager 1520 may support wireless communication at the device 1505 (e.g., a network entity, a UE) in accordance with examples as disclosed herein. For example, the communications manager 1520 may be configured as or otherwise support a means for outputting first control signaling indicating a DRX configuration associated with a set of DRX cycles. The communications manager 1520 may be configured as or otherwise support a means for outputting second control signaling during a first inactive duration and before a first active duration associated with a first DRX cycle of the set of DRX cycles associated with a second device (e.g., a UE 115), the second control signaling indicating that the first device has pending data for the second device, the second control signaling further including a request for feedback from the second device, the feedback indicating a capability for the second device to receive the pending data from the first device during the first active duration and an energy level of a power source associated with the second device. The communications manager 1520 may be configured as or otherwise support a means for communicating with the second device based on the second control signaling.

By including or configuring the communications manager 1520 in accordance with examples as described herein, the device 1505 may support techniques for more efficient utilization of communication resources and improved coordination between devices.

In some examples, the device 1505 may be equipped with circuitry including one or multiple circuit elements, such as resistors, transistors, capacitors, inductors, amplifiers, diodes, among other examples, that may be coupled (e.g., operatively, communicatively, functionally, electronically, or electrically) with each other to support energy harvesting operations at the device 1505, or any combination thereof. The circuitry may receive energy from one or more external energy sources and may process (e.g., collect, convert, transform) the energy via the one or multiple circuit elements, such as resistors, transistors, capacitors, inductors, amplifiers, diodes, among other examples, to charge a power source of the device 1505.

In some examples, the communications manager 1520 may be configured to perform various operations (e.g., receiving, monitoring, transmitting) using or otherwise in cooperation with the transceiver 1515, the one or more antennas 1525, or any combination thereof. Although the communications manager 1520 is illustrated as a separate component, in some examples, one or more functions described with reference to the communications manager 1520 may be supported by or performed by the processor 1540, the memory 1530, the code 1535, or any combination thereof. For example, the code 1535 may include instructions executable by the processor 1540 to cause the device 1505 to perform various aspects of wake up procedures as described herein, or the processor 1540 and the memory 1530 may be otherwise configured to perform or support such operations.

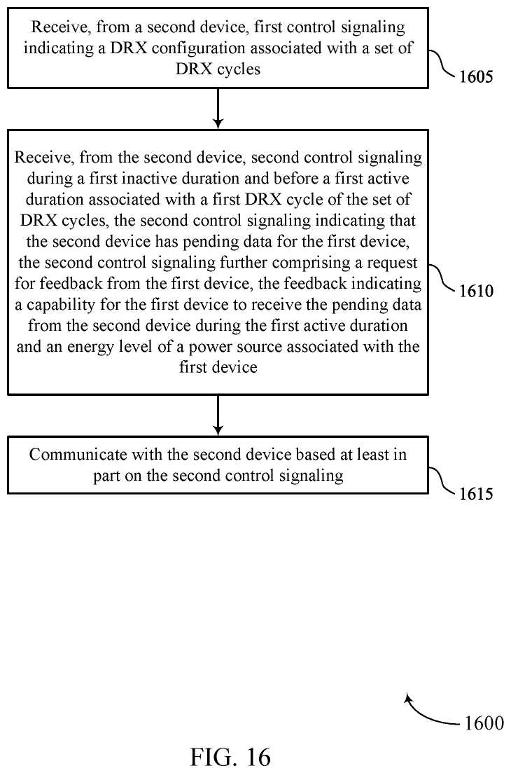

FIG. 16 shows a flowchart illustrating a method 1600 that supports wake up procedures in accordance with one or more aspects of the present disclosure. The operations of the method 1600 may be implemented by a first device (e.g., a UE 115) or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1605, the method may include receiving, from a second device, first control signaling indicating a DRX configuration associated with a set of DRX cycles. In some examples, the second device may be a network entity or a UE. The operations of 1605 may be performed in accordance with examples as disclosed herein. In some examples, aspects of the operations of 1605 may be performed by a configuration component 1025 as described with reference to FIG. 10.

At 1610, the method may include receiving, from the second device, second control signaling during a first inactive duration and before a first active duration associated with a first DRX cycle of the set of DRX cycles, the second control signaling indicating that the second device has pending data for the first device, the second control signaling further including a request for feedback from the first device, the feedback indicating a capability for the first device to receive the pending data from the second device during the first active duration and an energy level of a power source associated with the first device. The operations of 1610 may be performed in accordance with examples as disclosed herein. In some examples, aspects of the operations of 1610 may be performed by an indication component 1030 as described with reference to FIG. 10.

At 1615, the method may include communicating with the second device based on the second control signaling. The operations of 1615 may be performed in accordance with examples as disclosed herein. In some examples, aspects of the operations of 1615 may be performed by a data component 1035 as described with reference to FIG. 10.

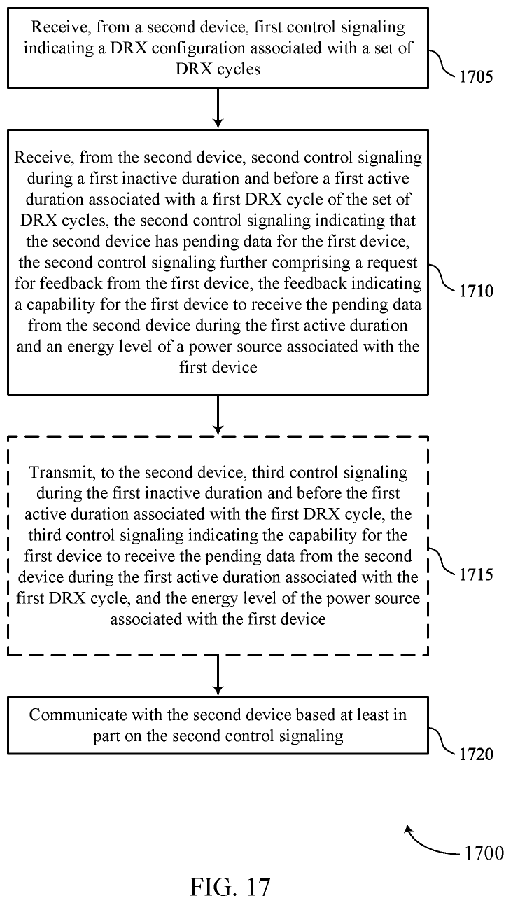

FIG. 17 shows a flowchart illustrating a method 1700 that supports wake up procedures in accordance with one or more aspects of the present disclosure. The operations of the method 1700 may be implemented by a first device (e.g., a UE 115) or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1705, the method may include receiving, from a second device, first control signaling indicating a DRX configuration associated with a set of DRX cycles. In some examples, the second device may be a network entity or a UE. The operations of 1705 may be performed in accordance with examples as disclosed herein. In some examples, aspects of the operations of 1705 may be performed by a configuration component 1025 as described with reference to FIG. 10.

At 1710, the method may include receiving, from the second device, second control signaling during a first inactive duration and before a first active duration associated with a first DRX cycle of the set of DRX cycles, the second control signaling indicating that the second device has pending data for the first device, the second control signaling further including a request for feedback from the first device, the feedback indicating a capability for the first device to receive the pending data from the second device during the first active duration and an energy level of a power source associated with the first device. The operations of 1710 may be performed in accordance with examples as disclosed herein. In some examples, aspects of the operations of 1710 may be performed by an indication component 1030 as described with reference to FIG. 10.

At 1715, the method may include transmitting, to the second device, third control signaling during the first inactive duration and before the first active duration associated with the first DRX cycle, the third control signaling indicating the capability for the first device to receive the pending data from the second device during the first active duration associated with the first DRX cycle, and the energy level of the power source associated with the first device. The operations of 1715 may be performed in accordance with examples as disclosed herein. In some examples, aspects of the operations of 1715 may be performed by an indication component 1030 as described with reference to FIG. 10.

At 1720, the method may include communicating with the second device based on the second control signaling. The operations of 1720 may be performed in accordance with examples as disclosed herein. In some examples, aspects of the operations of 1720 may be performed by a data component 1035 as described with reference to FIG. 10.

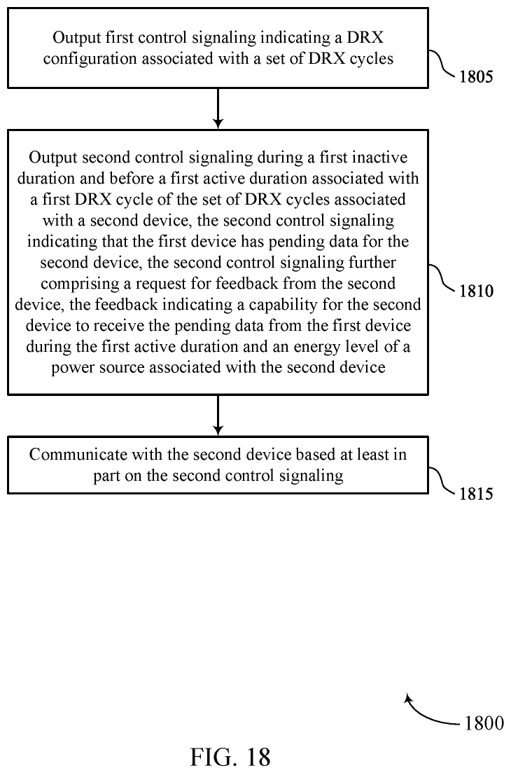

FIG. 18 shows a flowchart illustrating a method 1800 that supports wake up procedures in accordance with one or more aspects of the present disclosure. The operations of the method 1800 may be implemented by a first device (e.g., a UE 115, a network entity 105, or other network entity as described herein) or its components as described herein. For example, the operations of the method 1800 may be performed by a first device as described with reference to FIGS. 1 through 7 and 12 through 15. In some examples, a first device may execute a set of instructions to control the functional elements of the first device to perform the described functions. Additionally or alternatively, a first device may perform aspects of the described functions using special-purpose hardware.

At 1805, the method may include outputting first control signaling indicating a DRX configuration associated with a set of DRX cycles. The operations of 1805 may be performed in accordance with examples as disclosed herein. In some examples, aspects of the operations of 1805 may be performed by a configuration component 1425 as described with reference to FIG. 14.

At 1810, the method may include outputting second control signaling during a first inactive duration and before a first active duration associated with a first DRX cycle of the set of DRX cycles associated with a second device, the second control signaling indicating that the first device has pending data for the second device, the second control signaling further including a request for feedback from the second device, the feedback indicating a capability for the second device to receive the pending data from the first device during the first active duration and an energy level of a power source associated with the second device. In some examples, the second device may be a network entity or a UE. The operations of 1810 may be performed in accordance with examples as disclosed herein. In some examples, aspects of the operations of 1810 may be performed by an indication component 1430 as described with reference to FIG. 14.

At 1815, the method may include communicating with the second device based on the second control signaling. The operations of 1815 may be performed in accordance with examples as disclosed herein. In some examples, aspects of the operations of 1815 may be performed by a data component 1435 as described with reference to FIG. 14.

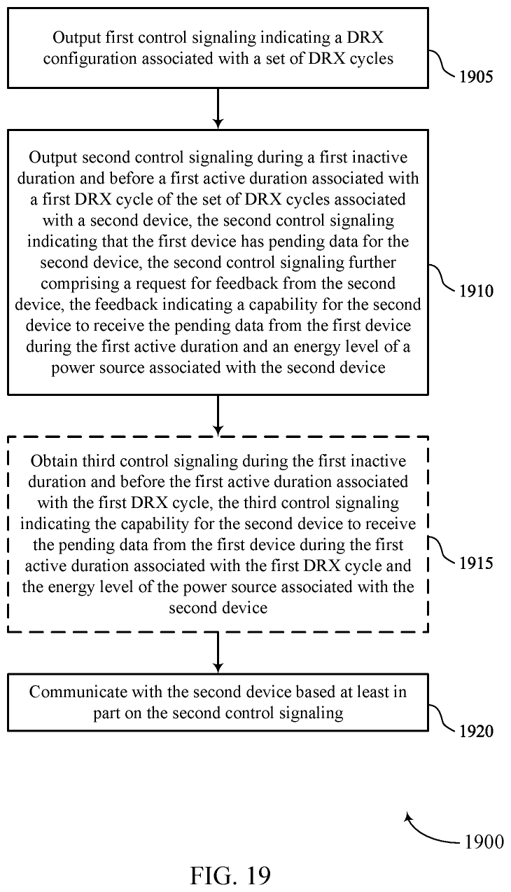

FIG. 19 shows a flowchart illustrating a method 1900 that supports wake up procedures in accordance with one or more aspects of the present disclosure. The operations of the method 1900 may be implemented by a first device (e.g., a UE 115, a network entity 105, or other network entity as described herein) or its components as described herein. For example, the operations of the method 1900 may be performed by a first device as described with reference to FIGS. 1 through 7 and 12 through 15. In some examples, a first device may execute a set of instructions to control the functional elements of the first device to perform the described functions. Additionally or alternatively, a first device may perform aspects of the described functions using special-purpose hardware.

At 1905, the method may include outputting first control signaling indicating a DRX configuration associated with a set of DRX cycles. The operations of 1905 may be performed in accordance with examples as disclosed herein. In some examples, aspects of the operations of 1905 may be performed by a configuration component 1425 as described with reference to FIG. 14.

At 1910, the method may include outputting second control signaling during a first inactive duration and before a first active duration associated with a first DRX cycle of the set of DRX cycles associated with a second device, the second control signaling indicating that the first device has pending data for the second device, the second control signaling further including a request for feedback from the second device, the feedback indicating a capability for the second device to receive the pending data from the first device during the first active duration and an energy level of a power source associated with the second device. In some examples, the second device may be a network entity or a UE. The operations of 1910 may be performed in accordance with examples as disclosed herein. In some examples, aspects of the operations of 1910 may be performed by an indication component 1430 as described with reference to FIG. 14.

At 1915, the method may include obtaining third control signaling during the first inactive duration and before the first active duration associated with the first DRX cycle, the third control signaling indicating the capability for the second device to receive the pending data from the first device during the first active duration associated with the first DRX cycle and the energy level of the power source associated with the second device. The operations of 1915 may be performed in accordance with examples as disclosed herein. In some examples, aspects of the operations of 1915 may be performed by an indication component 1430 as described with reference to FIG. 14.

At 1920, the method may include communicating with the second device based on the second control signaling. The operations of 1920 may be performed in accordance with examples as disclosed herein. In some examples, aspects of the operations of 1920 may be performed by a data component 1435 as described with reference to FIG. 14.

It should be noted that the methods described herein describe possible implementations, and that the operations and the steps may be rearranged or otherwise modified and that other implementations are possible. Further, aspects from two or more of the methods may be combined.

The following provides an overview of aspects of the present disclosure:

Aspect 1: An apparatus for wireless communication, comprising: a processor; and memory coupled with the processor, the processor configured to: receive, from a second apparatus, first control signaling indicating a DRX configuration associated with a set of DRX cycles; receive, from the second apparatus, second control signaling during a first inactive duration and before a first active duration associated with a first DRX cycle of the set of DRX cycles, the second control signaling indicating that the second apparatus has pending data for the apparatus, the second control signaling further comprising a request for feedback from the apparatus, the feedback indicating a capability for the apparatus to receive the pending data from the second apparatus during the first active duration and an energy level of a power source associated with the apparatus; and communicate with the second apparatus based at least in part on the second control signaling.

Aspect 2: The apparatus of aspect 1, wherein the processor is further configured to transmit, from the second apparatus, third control signaling during the first inactive duration and before the first active duration associated with the first DRX cycle, the third control signaling indicating the capability for the apparatus to receive the pending data from the second apparatus during the first active duration associated with the first DRX cycle, and the energy level of the power source associated with the apparatus.

Aspect 3: The apparatus of aspect 2, wherein the processor is further configured to determine the energy level of the power source associated with the apparatus, wherein to receive, from the second apparatus, the second control signaling, is further based at least in part on the energy level of the power source associated with the apparatus, and wherein to transmit, to the second apparatus, the third control signaling is further based at least in part on the energy level of the power source associated with the apparatus.

Aspect 4: The apparatus of aspect 3, wherein, to communicate with the second apparatus, the processor is configured to receive the pending data during the first active duration associated with the first DRX cycle based at least in part on the third control signaling and the energy level of the power source associated with the apparatus.

Aspect 5: The apparatus of any of aspects 3 through 4, wherein the processor is further configured to decode the second control signaling based at least in part on the energy level of the power source associated with the apparatus satisfying an energy threshold, wherein to transmit, to the second apparatus, the third control signaling is further based at least in part on the decoded second control signaling.

Aspect 6: The apparatus of any of aspects 3 through 5, wherein, to receive the second control signaling, the processor is configured to monitor for the second control signaling, wherein the processor is further configured to: refrain from decoding the second control signaling based at least in part on the energy level of the power source associated with the apparatus being below an energy threshold.

Aspect 7: The apparatus of any of aspects 3 through 6, wherein to, transmit, to the second apparatus, the third control signaling is further based at least in part on the energy level of the power source associated with the apparatus satisfying a threshold.

Aspect 8: The apparatus of aspect 7, wherein the processor is further configured to monitor for the second control signaling during the first inactive duration and before the first active duration associated with the first DRX cycle of the set of DRX cycles based at least in part on the energy level of the power source associated with the apparatus satisfying the threshold; and transmit the third control signaling during the first inactive duration and before the first active duration associated with the first DRX cycle based at least in part on the energy level of the power source associated with the apparatus satisfying the threshold, wherein the first inactive duration is based at least in part on a charging rate and a time for the energy level of the power source associated with the apparatus to satisfy the threshold.

Aspect 9: The apparatus of any of aspects 7 through 8, wherein the processor is further configured to refrain to monitor for the second control signaling during the first inactive duration and before the first active duration associated with the first DRX cycle of the set of DRX cycles based at least in part on the energy level of the power source associated with the apparatus satisfying the threshold; and refrain to transmit the third control signaling during the first inactive duration and before the first active duration associated with the first DRX cycle based at least in part on the energy level of the power source associated with the apparatus satisfying the threshold, wherein the first inactive duration is based at least in part on a charging rate and a time for the energy level of the power source associated with the apparatus to satisfy the threshold.

Aspect 10: The apparatus of any of aspects 7 through 9, wherein the processor is further configured to refrain to monitor for the second control signaling during the first inactive duration and before the first active duration associated with the first DRX cycle of the set of DRX cycles based at least in part on the energy level of the power source associated with the apparatus satisfying the threshold; and transmit the third control signaling during the first inactive duration and before the first active duration associated with the first DRX cycle based at least in part on the energy level of the power source associated with the apparatus satisfying the threshold, wherein the first inactive duration is based at least in part on a charging rate and a time for the energy level of the power source associated with the apparatus to satisfy the threshold.

Aspect 11: The apparatus of any of aspects 3 through 10, wherein the third control signaling indicates a time interval for energy harvesting at the apparatus, and wherein the processor is further configured to charge the power source associated with the apparatus based at least in part on the time interval, the time interval comprising one or more DRX cycles of the set of DRX cycles following the first DRX cycle based at least in part on the time interval for energy harvesting at the apparatus, and wherein, to charge the power source associated with the apparatus, the processor is configured to accumulate solar energy, thermal energy, vibrational energy, radio frequency energy, or any combination thereof.

Aspect 12: The apparatus of aspect 11, wherein the processor is further configured to receive, from the second apparatus, fourth control signaling during a second inactive duration before a second active duration associated with a second DRX cycle for the wireless communication based at least in part on the time interval, the fourth control signaling indicating the pending data associated with the wireless communication and the request for the capability of the apparatus to receive the pending data during the second active duration associated with the second DRX cycle; transmit, to the second apparatus, fifth control signaling during the second inactive duration before the second active duration associated with the second DRX cycle, the fifth control signaling indicating the capability of the apparatus to receive the pending data during the second active duration associated with the second DRX cycle, the capability indicating the energy level of the power source associated with the apparatus; and receive the pending data during the second active duration associated with the second DRX cycle based at least in part on the fifth control signaling and the energy level of the power source associated with the apparatus.

Aspect 13: The apparatus of any of aspects 2 through 12, wherein the processor is further configured to determine a payload associated with the pending data based at least in part on the second control signaling, wherein to transmit, to the second apparatus, the third control signaling is further based at least in part on the payload associated with the pending data and the energy level of the power source associated with the apparatus.

Aspect 14: The apparatus of any of aspects 2 through 13, wherein the processor is further configured to determine a path loss value based at least in part on the second control signaling, wherein to transmit, to the second apparatus, the third control signaling is further based at least in part on the path loss value and the energy level of the power source associated with the apparatus.

Aspect 15: The apparatus of aspect 14, wherein the processor is further configured to demultiplex a set of reference signals associated with the second control signaling, wherein to determine the path loss value is further based at least in part on the demultiplexed set of reference signals associated with the second control signaling.

Aspect 16: The apparatus of any of aspects 2 through 15, wherein the processor is further configured to determine a maximum number of transport blocks or a maximum number of bits, or both, decodable by the apparatus during the first active duration of the first DRX cycle, wherein the third control signal indicates the maximum number of transport blocks or the maximum number of bits, or both, decodable by the apparatus during the first active duration of the first DRX cycle.

Aspect 17: The apparatus of any of aspects 2 through 16, wherein the third control signaling indicates an overhead of each transport block transmission or reception associated with receiving a downlink transmission, transmitting an uplink transmission, receiving a sidelink transmission, or transmitting the sidelink transmission, or any combination thereof.

Aspect 18: The apparatus of any of aspects 2 through 17, wherein the processor is further configured to determine a transport block size associated with the pending data; and determine a resource allocation or a modulation coding scheme associated with the pending data, or both, based at least in part on the transport block size associated with the pending data, wherein to communicate with the second apparatus is further based at least in part on the resource allocation or the modulation coding scheme associated with the pending data, or both.

Aspect 19: The apparatus of any of aspects 2 through 18, wherein the third control signaling indicates a per-resource power level associated with the apparatus, or a number of DRX cycles to skip the wireless communication with the apparatus, or both.

Aspect 20: The apparatus of any of aspects 2 through 19, wherein the processor is further configured to receive fourth control signaling indicating a configuration comprising a set of energy states; and determine an energy state associated with the set of energy states of the apparatus based at least in part on the energy level of the power source associated with the apparatus, wherein to receive, from the second apparatus, the second control signaling is further based at least in part on the energy state, and wherein to transmit, to the second apparatus, the third control signaling is further based at least in part on the energy state.

Aspect 21: The apparatus of aspect 20, wherein the set of energy states comprises a first energy state associated with a first energy level, a second energy state associated with a second energy level, a third energy state associated with a third energy level, or any combination thereof, the first energy level is greater than the second energy level and the third energy level, the second energy level is greater than the third energy level, and the second energy state comprises a subset of energy states.

Aspect 22: The apparatus of any of aspects 1 through 21, wherein the processor is further configured to transmit, to the second apparatus, third control signaling indicating the capability for the apparatus to receive the pending data from the second apparatus based at least in part on a condition, the energy level of the power source associated with the apparatus, an energy state associated with the apparatus, or a periodicity reporting of an energy level of the power source associated with the apparatus, or any combination thereof.

Aspect 23: The apparatus of any of aspects 1 through 22, wherein the processor is further configured to transmit, to the second apparatus, third control signaling comprising a buffer status report or a power headroom report, or both, indicating power, energy units, or total energy associated with a set of energy units.

Aspect 24: The apparatus of any of aspects 1 through 23, wherein an energy level of the power source associated with the apparatus corresponds to an energy state of the apparatus, a maximum buffer status report associated with the apparatus, a maximum number of buffer status report bits associated with the apparatus, or any combination thereof.

Aspect 25: The apparatus of any of aspects 1 through 24, wherein the processor is further configured to transmit, to the second apparatus, third control signaling during the first inactive duration before the first active duration associated with the first DRX cycle, the third control signaling indicating the capability for the apparatus to receive the pending data from the second apparatus during the first active duration associated with the first DRX cycle and the energy level of the power source associated with the apparatus, wherein the third control signal indicates an energy state associated with the apparatus, and wherein the third control signaling comprises an uplink channel or a sidelink channel multiplexed with control information or data.

Aspect 26: An apparatus for wireless communication, comprising: a processor; and memory coupled with the processor, the processor configured to: output first control signaling indicating a DRX configuration associated with a set of DRX cycles; output second control signaling during a first inactive duration and before a first active duration associated with a first DRX cycle of the set of DRX cycles associated with a second apparatus, the second control signaling indicating that the apparatus has pending data for the second apparatus, the second control signaling further comprising a request for feedback from the second apparatus, the feedback indicating a capability for the second apparatus to receive the pending data from the apparatus during the first active duration and an energy level of a power source associated with the second apparatus; and communicate with the second apparatus based at least in part on the second control signaling.

Aspect 27: The apparatus of aspect 26, wherein the processor is further configured to obtain third control signaling during the first inactive duration and before the first active duration associated with the first DRX cycle, the third control signaling indicating the capability for the second apparatus to receive the pending data from the apparatus during the first active duration associated with the first DRX cycle and the energy level of the power source associated with the second apparatus.

Aspect 28: The apparatus of aspect 27, wherein the third control signaling indicates a time interval for energy harvesting at the second apparatus.

Aspect 29: The apparatus of any of aspects 26 through 28, wherein the third control signaling indicates a per-resource power level associated with the UE, or a number of DRX cycles to skip the wireless communication with the UE, or both.

Aspect 30: The apparatus of any of aspects 26 through 29, wherein the third control signaling comprises a buffer status report or a power headroom report, or both, indicating power, energy units, or total energy associated with a set of energy units.

Aspect 31: The apparatus of any of aspects 26 through 30, wherein, to communicate with the UE, the processor is configured to output the pending data during the first active duration associated with the first DRX cycle based at least in part on the third control signaling and the energy level of the power source associated with the UE.

Aspect 32: A method for wireless communication at a device to perform any of aspects 1 through 25.

Aspect 33: An apparatus comprising at least one means for performing any of aspects 1 through 25.

Aspect 34: A non-transitory computer-readable medium storing code the code comprising instructions executable by a processor to perform any of aspects 1 through 25.

Aspect 35: A method for wireless communication at a device to perform any of aspects 26 through 31.

Aspect 36: An apparatus comprising at least one means for performing any of aspects 26 through 31.

Aspect 37: A non-transitory computer-readable medium storing code the code comprising instructions executable by a processor to perform any of aspects 26 through 31.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication, comprising:
a processor; and
memory coupled with the processor, the processor configured to:
receive, from a second apparatus, first control signaling indicating a discontinuous reception configuration associated with a set of discontinuous reception cycles;
receive, from the second apparatus, second control signaling during a first inactive duration and before a first active duration associated with a first discontinuous reception cycle of the set of discontinuous reception cycles, the second control signaling indicating that the second apparatus has pending data for the apparatus, the second control signaling further comprising a request for feedback from the apparatus, the feedback indicating a capability for the apparatus to receive the pending data from the second apparatus during the first active duration and an energy level of a power source associated with the apparatus; and
communicate with the second apparatus based at least in part on the second control signaling.

2. The apparatus of claim 1, wherein the processor is further configured to:
transmit, from the second apparatus, third control signaling during the first inactive duration and before the first active duration associated with the first discontinuous reception cycle, the third control signaling indicating the capability for the apparatus to receive the pending data from the second apparatus during the first active duration associated with the first discontinuous reception cycle, and the energy level of the power source associated with the apparatus.

3. The apparatus of claim 2, wherein the processor is further configured to:
determine the energy level of the power source associated with the apparatus,
wherein to receive, from the second apparatus, the second control signaling, is further based at least in part on the energy level of the power source associated with the apparatus, and wherein to transmit, to the second apparatus, the third control signaling is further based at least in part on the energy level of the power source associated with the apparatus.

4. The apparatus of claim 3, wherein, to communicate with the second apparatus, the processor is configured to:
receive the pending data during the first active duration associated with the first discontinuous reception cycle based at least in part on the third control signaling and the energy level of the power source associated with the apparatus.

5. The apparatus of claim 3, wherein the processor is further configured to:
decode the second control signaling based at least in part on the energy level of the power source associated with the apparatus satisfying an energy threshold,
wherein to transmit, to the second apparatus, the third control signaling is further based at least in part on the decoded second control signaling.

6. The apparatus of claim 3, wherein, to receive the second control signaling, the processor is configured to:
monitor for the second control signaling, wherein the processor is further configured to:
refrain from decoding the second control signaling based at least in part on the energy level of the power source associated with the apparatus being below an energy threshold.

7. The apparatus of claim 3, wherein to, transmit, to the second apparatus, the third control signaling is further based at least in part on the energy level of the power source associated with the apparatus satisfying a threshold.

8. The apparatus of claim 7, wherein the processor is further configured to:
monitor for the second control signaling during the first inactive duration and before the first active duration associated with the first discontinuous reception cycle of the set of discontinuous reception cycles based at least in part on the energy level of the power source associated with the apparatus satisfying the threshold; and
transmit the third control signaling during the first inactive duration and before the first active duration associated with the first discontinuous reception cycle based at least in part on the energy level of the power source associated with the apparatus satisfying the threshold, wherein the first inactive duration is based at least in part on a charging rate and a time for the energy level of the power source associated with the apparatus to satisfy the threshold.

9. The apparatus of claim 7, wherein the processor is further configured to:
refrain to monitor for the second control signaling during the first inactive duration and before the first active duration associated with the first discontinuous reception cycle of the set of discontinuous reception cycles based at least in part on the energy level of the power source associated with the apparatus satisfying the threshold; and
refrain to transmit the third control signaling during the first inactive duration and before the first active duration associated with the first discontinuous reception cycle based at least in part on the energy level of the power source associated with the apparatus satisfying the threshold, wherein the first inactive duration is based at least in part on a charging rate and a time for the energy level of the power source associated with the apparatus to satisfy the threshold.

10. The apparatus of claim 7, wherein the processor is further configured to:
refrain to monitor for the second control signaling during the first inactive duration and before the first active duration associated with the first discontinuous reception cycle of the set of discontinuous reception cycles based at least in part on the energy level of the power source associated with the apparatus satisfying the threshold; and
transmit the third control signaling during the first inactive duration and before the first active duration associated with the first discontinuous reception cycle based at least in part on the energy level of the power source associated with the apparatus satisfying the threshold, wherein the first inactive duration is based at least in part on a charging rate and a time for the energy level of the power source associated with the apparatus to satisfy the threshold.

11. The apparatus of claim 3, wherein the third control signaling indicates a time interval for energy harvesting at the apparatus, and wherein the processor is further configured to:
charge the power source associated with the apparatus based at least in part on the time interval, the time interval comprising one or more discontinuous reception cycles of the set of discontinuous reception cycles following the first discontinuous reception cycle based at least in part on the time interval for energy harvesting at the apparatus, and wherein, to charge the power source associated with the apparatus, the processor is configured to accumulate solar energy, thermal energy, vibrational energy, radio frequency energy, or any combination thereof.

12. The apparatus of claim 11, wherein the processor is further configured to:
receive, from the second apparatus, fourth control signaling during a second inactive duration before a second active duration associated with a second discontinuous reception cycle for the wireless communication based at least in part on the time interval, the fourth control signaling indicating the pending data associated with the wireless communication and the request for the capability of the apparatus to receive the pending data during the second active duration associated with the second discontinuous reception cycle;
transmit, to the second apparatus, fifth control signaling during the second inactive duration before the second active duration associated with the second discontinuous reception cycle, the fifth control signaling indicating the capability of the apparatus to receive the pending data during the second active duration associated with the second discontinuous reception cycle, the capability indicating the energy level of the power source associated with the apparatus; and
receive the pending data during the second active duration associated with the second discontinuous reception cycle based at least in part on the fifth control signaling and the energy level of the power source associated with the apparatus.

13. The apparatus of claim 2, wherein the processor is further configured to:
determine a payload associated with the pending data based at least in part on the second control signaling,
wherein to transmit, to the second apparatus, the third control signaling is further based at least in part on the payload associated with the pending data and the energy level of the power source associated with the apparatus.

14. The apparatus of claim 2, wherein the processor is further configured to:
determine a path loss value based at least in part on the second control signaling,
wherein to transmit, to the second apparatus, the third control signaling is further based at least in part on the path loss value and the energy level of the power source associated with the apparatus.

15. The apparatus of claim 14, wherein the processor is further configured to:
demultiplex a set of reference signals associated with the second control signaling,
wherein to determine the path loss value is further based at least in part on the demultiplexed set of reference signals associated with the second control signaling.

16. The apparatus of claim 2, wherein the processor is further configured to:
determine a maximum number of transport blocks or a maximum number of bits, or both, decodable by the apparatus during the first active duration of the first discontinuous reception cycle,
wherein the third control signal indicates the maximum number of transport blocks or the maximum number of bits, or both, decodable by the apparatus during the first active duration of the first discontinuous reception cycle.

17. The apparatus of claim 2, wherein the third control signaling indicates an overhead of each transport block transmission or reception associated with receiving a downlink transmission, transmitting an uplink transmission, receiving a sidelink transmission, or transmitting the sidelink transmission, or any combination thereof.

18. The apparatus of claim 2, wherein the processor is further configured to:
determine a transport block size associated with the pending data; and
determine a resource allocation or a modulation coding scheme associated with the pending data, or both, based at least in part on the transport block size associated with the pending data,
wherein to communicate with the second apparatus is further based at least in part on the resource allocation or the modulation coding scheme associated with the pending data, or both.

19. The apparatus of claim 2, wherein the third control signaling indicates a per-resource power level associated with the apparatus, or a number of discontinuous reception cycles to skip the wireless communication with the apparatus, or both.

20. The apparatus of claim 2, wherein the processor is further configured to:
receive fourth control signaling indicating a configuration comprising a set of energy states; and
determine an energy state associated with the set of energy states of the apparatus based at least in part on the energy level of the power source associated with the apparatus,
wherein to receive, from the second apparatus, the second control signaling is further based at least in part on the energy state, and wherein to transmit, to the second apparatus, the third control signaling is further based at least in part on the energy state.

21. The apparatus of claim 20, wherein:
the set of energy states comprises a first energy state associated with a first energy level, a second energy state associated with a second energy level, a third energy state associated with a third energy level, or any combination thereof,
the first energy level is greater than the second energy level and the third energy level,
the second energy level is greater than the third energy level, and
the second energy state comprises a subset of energy states.

22. The apparatus of claim 1, wherein the processor is further configured to:
transmit, to the second apparatus, third control signaling indicating the capability for the apparatus to receive the pending data from the second apparatus based at least in part on a condition, the energy level of the power source associated with the apparatus, an energy state associated with the apparatus, or a periodicity reporting of an energy level of the power source associated with the apparatus, or any combination thereof.

23. The apparatus of claim 1, wherein the processor is further configured to:
transmit, to the second apparatus, third control signaling comprising a buffer status report or a power headroom report, or both, indicating power, energy units, or total energy associated with a set of energy units.

24. The apparatus of claim 1, wherein an energy level of the power source associated with the apparatus corresponds to an energy state of the apparatus, a maximum buffer status report associated with the apparatus, a maximum number of buffer status report bits associated with the apparatus, or any combination thereof.

25. The apparatus of claim 1, wherein the processor is further configured to:
transmit, to the second apparatus, third control signaling during the first inactive duration before the first active duration associated with the first discontinuous reception cycle, the third control signaling indicating the capability for the apparatus to receive the pending data from the second apparatus during the first active duration associated with the first discontinuous reception cycle and the energy level of the power source associated with the apparatus,
wherein the third control signal indicates an energy state associated with the apparatus, and wherein the third control signaling comprises an uplink channel or a sidelink channel multiplexed with control information or data.

26. An apparatus for wireless communication, comprising:
a processor; and
memory coupled with the processor, the processor configured to:
output first control signaling indicating a discontinuous reception configuration associated with a set of discontinuous reception cycles;
output second control signaling during a first inactive duration and before a first active duration associated with a first discontinuous reception cycle of the set of discontinuous reception cycles associated with a second apparatus, the second control signaling indicating that the apparatus has pending data for the second apparatus, the second control signaling further comprising a request for feedback from the second apparatus, the feedback indicating a capability for the second apparatus to receive the pending data from the apparatus during the first active duration and an energy level of a power source associated with the second apparatus; and
communicate with the second apparatus based at least in part on the second control signaling.

27. The apparatus of claim 26, wherein the processor is further configured to:
obtain third control signaling during the first inactive duration and before the first active duration associated with the first discontinuous reception cycle, the third control signaling indicating the capability for the second apparatus to receive the pending data from the apparatus during the first active duration associated with the first discontinuous reception cycle and the energy level of the power source associated with the second apparatus.

28. The apparatus of claim 27, wherein the third control signaling indicates a time interval for energy harvesting at the second apparatus.

29. A method for wireless communication at a first device, comprising:
receiving, from a second device, first control signaling indicating a discontinuous reception configuration associated with a set of discontinuous reception cycles;
receiving, from a second device, second control signaling during a first inactive duration and before a first active duration associated with a first discontinuous reception cycle of the set of discontinuous reception cycles, the second control signaling indicating that the second device has pending data for the first device, the second control signaling further comprising a request for feedback from the first device, the feedback indicating a capability for the first device to receive the pending data from the second device during the first active duration and an energy level of a power source associated with the first device; and
communicating with the second device based at least in part on the second control signaling.

30. A method for wireless communication at a first device, comprising:
outputting first control signaling indicating a discontinuous reception configuration associated with a set of discontinuous reception cycles;
outputting second control signaling during a first inactive duration and before a first active duration associated with a first discontinuous reception cycle of the set of discontinuous reception cycles associated with a second device, the second control signaling indicating pending data for the second device, the second control signaling further comprising a request for feedback from the second device, the feedback indicating a capability for the second device to receive the pending data from the first device during the first active duration and an energy level of a power source associated with the second device; and
communicating with the second device based at least in part on the second control signaling.
